(19) United States
(12) Patent Application Publication
(10) Pub. No.: US 2010/0213085 A1
(43) Pub. Date: Aug. 26, 2010

(54) APPARATUS, SYSTEM, AND METHOD FOR SELECTIVELY MIXING TWO SUBSTANCES

(76) Inventor: Nicole Belnap, Vernal, UT (US)

Correspondence Address: Kunzler Needham Massey & Thorpe, 8 EAST BROADWAY, SUITE 600, SALT LAKE CITY, UT, 84111, US

(21) Appl. No.: 12/713,139

(22) Filed: Feb. 25, 2010

Related U.S. Application Data
(60) Provisional application No. 61/155,490, filed on Feb. 25, 2009.
(60) Provisional application No. 61/155,495, filed on Feb. 25, 2009.

(51) Int. Cl. B01F 15/02; B65D 25/08; B65D 1/04; A61J 11/00

(52) U.S. Cl. 206/219; 366/165.4; 215/6; 215/11.1

(57) ABSTRACT

An apparatus and method for storing, mixing, and delivering a powder solid and a fluid such as baby formula and water without the risk of product contamination or of the product expiring. The apparatus includes a first compartment, a second compartment, a passage in a bottom of the first compartment, and a seal that seals the passage in the bottom of the first compartment. Communication between the first compartment and the second compartment is achieved by longitudinally displacing the second compartment with respect to the first compartment. The longitudinal displacement of the second compartment causes the second compartment to be withdrawn from the first compartment. The seal is attached to the top of the second compartment such that the displacement of the second compartment with respect to the first compartment causes the seal to be displaced from the passage.

### CROSS-REFERENCES TO RELATED APPLICATIONS

This application claims priority to U.S. Provisional Patent Application No. 61/155,490 entitled “Container Communication Apparatus and Method” and filed on Feb. 25, 2009, for Nicole Belnap, which is incorporated herein by reference. This application also claims priority to U.S. Provisional Patent Application No. 61/155,495 entitled “Apparatus and Method for Mixing Infant Formula” and filed on Feb. 25, 2009, for Nicole Belnap, which is incorporated herein by reference. U.S. patent application Ser. No. ______ entitled “Apparatus and Method for Mixing Infant Formula” and filed on Feb. 25, 2010, for Nicole Belnap, is incorporated by reference as if fully set out herein.

### FIELD OF THE INVENTION

This invention relates to the storage and mixing of two materials contained within two compartments, and more particularly to selective storage mixing of infant formula in a two compartment mixing device.

### BACKGROUND

Baby bottles have long been used to deliver nutrition to small children. Bottles can carry fluid in many forms. While some fluids such as water or drinks can be stored at room temperature for extended periods of time without fear of spoiling, other fluids have a very limited life. Once the powder formula is mixed and activated with water, it has only a few hours before the mixture will spoil. The mixing of the powder formula with water poses many challenges especially when one is away from the home or a kitchen. There is the problem of measuring out an appropriate amount of powder formula, adding it to the bottle, and mixing the two substances into one while maintaining cleanliness on the outside of the bottle as well as sanitary conditions on the inside of the bottle. Keeping this action sanitary and clean takes time and effort.

Time is very valuable in the preparation of formula, since small children are not able or willing to wait long for nutrition, making the situation sometimes very uncomfortable for both the caregiver as well as people around the hungry child. Adding to the frustration of the caregiver and child is the frustration incurred by not having appropriate facilities to mix the formula and water. This is especially germane in a crowded airplane, restaurant, or other public setting where one may need to feed a child.

### SUMMARY OF THE INVENTION

From the foregoing discussion, it should be apparent that a need exists for an apparatus, system, and method for storing powder formula and water that allows for the selective mixing of the two substances in an efficient and clean manner.

The present invention has been developed in response to the present state of the art, and in particular, in response to the problems and needs in the art that have not yet been fully solved by currently available baby bottles. Accordingly, the present invention has been developed to provide an apparatus and method for storing, mixing, and delivering baby formula that overcome many or all shortcomings in the art.

In one aspect of the invention, an apparatus for selectively mixing and delivering formula to a child, the apparatus comprises two compartments with a passage that is disposed between the two compartments. The passage is blocked and can be electively moved and unblocked. The individual compartments are generally cylindrical, making the apparatus cylindrical as well. The apparatus also comprises of snap rings and grooves that are disposed along the edges of the compartments allowing the compartments to be joined and mated. The rings and grooves also allow for the compartments to rotate in relation to one another. The rings and grooves are configured in a way to allow for the rotation to be selectively limited by the operator of the device.

The apparatus also comprises a membrane that is disposed between the two compartments of the apparatus. This membrane is configured to selectively block the passage of water and formula between the two compartments. The membrane that separates the two compartments comprises passages and blockages. The blockage can be configured to wedge into one of the compartments and seal the passage. Once the blockage is established, communication of the formula and water is effectively inhibited.

In a further embodiment of the invention, a method of storing, mixing, and delivering baby formula to a child includes filling a first compartment with water. The first compartment is then sealed with a plug and joined with a second compartment that has been filled with the powder formula. Once prepared and joined, the two compartments effectively separate and store formula powder and water. Once activation is desired, the two compartments are pulled apart by the user. By pulling apart the two compartments, the blockage is removed, and the passage is aligned. Aligning the passage, allows for the powder formula and water to freely flow and mix, activating the formula drink. Once activated, the formula can be served to a child through a nipple located at the top of the apparatus.

In one embodiment of the invention the apparatus for selectively mixing multiple substances includes a first compartment, a second compartment, a passage disposed between the first compartment and the second compartment, and a seal configured to selectively block the passage. In certain embodiments the first compartment and the second compartment comprise a similar axis. The first and second compartment may be selectively displaced in relation to one another along the similar axis to remove the seal from the passage. In one embodiment the first compartment, the second compartment, and the seal are configured to individually accept selective motion that longitudinally displaces the seal from the passage. In another embodiment the second compartment rotates in relation to the first compartment to longitudinally displace the seal from the passage.

The apparatus may also include a second compartment receiving recess attached to the first compartment. The second compartment receiving recess receives the second compartment. In certain embodiments the longitudinal displacement of second compartment withdraws the second compartment from the second compartment receiving recess which may in turn remove the seal from the passage.

In a further embodiment the apparatus includes a pin disposed through a wall of the second compartment receiving recess. The pin engages a groove in a wall of the second compartment. The groove has at least one section at an angle greater than ninety degrees with respect to a common axis between first compartment and the second compartment. The angle of the at least one section may force the pin to a position further away from a top of the second compartment when the second compartment is rotated in a first direction causing the second compartment to be positioned deeper within in the second compartment receiving recess. Rotation of the second compartment with respect to the first compartment in a second direction forces the pin to a position closer to a top of the second compartment such that the second compartment is positioned shallower in the second compartment receiving recess.

An apparatus for feeding a child is also disclosed. The apparatus capable of selectively mixing a first substance and a second substance includes a first compartment having a first end and a second end. The first compartment retains a first substance. The first compartment includes a passage through the second end of the first compartment. The apparatus also includes a second compartment having a first end and a second end. The second compartment retains a second substance. A seal is attached to the first end of the second compartment. A second compartment receiving recess is attached to the second end of the first compartment. The second compartment is received within the second compartment receiving recess such that the seal is positioned against the passage in the second end of the first compartment. A pin is disposed through the second compartment receiving recess. The pin engages a groove in the second compartment. The groove in the second compartment has at least one section at an angle greater than ninety degrees with respect to a common axis between first compartment and the second compartment. Rotation of the second compartment with respect to the first compartment in a first direction forces the pin to a position further away from the first end of the second compartment. By forcing the pin to a position further away from the first end of the second compartment, the second compartment is positioned deeper within the second compartment receiving recess. Rotation of the second compartment with respect to the first compartment in a second direction forces the pin to a position closer to the first end of the second compartment. By forcing the pin to a position closer to the first end of the second compartment the second compartment is positioned shallower in the second compartment receiving recess and displaces the seal from the passage in the second end of the first housing.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments illustrated in the appended drawings, which depict only typical embodiments of the invention and are not to be considered limiting of its scope, in which:

FIG. 1 is a perspective view illustrating the front of one embodiment of a baby bottle according to the present invention.

FIG. 2 is an exploded perspective view of the baby bottle illustrating the front of one embodiment of a baby bottle according to the present invention.

FIG. 2A is an exploded perspective view of the baby bottle illustrating the front of one embodiment of a baby bottle according to the present invention.

FIG. 3 is an exploded perspective view of the first compartment, the second compartment, the membrane, and the membrane plug of the baby bottle of FIG. 2.

FIG. 3A is a bottom elevational view of a membrane plug of one embodiment of a baby bottle according to the present invention.

FIG. 3B is a bottom elevational view of a membrane of one embodiment of a baby bottle according to the present invention.

FIG. 3C is a cross section view of the membrane plug of FIG. 3A and a cross section of membrane of FIG. 3B of one embodiment of a baby bottle according to the present invention.

FIG. 4 is a perspective view illustrating the front of one embodiment of a baby bottle according to the present invention.

FIG. 5 is a schematic flow chart diagram illustrating an embodiment of a method of preparing, mixing, and delivering baby formula according to the present invention.

FIG. 6 is a top elevational view of an embodiment of a plug and a membrane according to the present invention.

FIG. 7 is a top elevational view of an embodiment of a plug and a membrane according to the present invention.

FIG. 8 is a side view illustrating the front of one embodiment of a baby bottle according to the present invention.

FIG. 8A is a cross section view of the apparatus of FIG. 8 according to the present invention.

FIG. 9 is a perspective view of the apparatus illustrating one embodiment of the present invention.

FIG. 10 is a partial top elevational perspective of a sealing system of the apparatus according to one embodiment of the present invention.

FIG. 10A is a side view of the sealing system of FIG. 10 according to one embodiment of the present invention.

FIG. 10B is a cross section view of sealing system of FIG. 10A according to one embodiment of the present invention.

FIG. 11 is a front perspective view of the apparatus according to one embodiment of the present invention.

FIG. 12 is a front perspective of the first compartment of the apparatus of FIG. 11 according to one embodiment of the present invention.

FIG. 13 is a perspective view of the second compartment of the apparatus of FIG. 11 according to one embodiment of the present invention.

FIG. 14 is a perspective view of the top of the second compartment sealing attachment of the sealing system of the apparatus of FIG. 11 according to one embodiment of the present invention.

FIG. 15 is a perspective view of the bottom of the second compartment sealing attachment of the sealing system of the apparatus of FIG. 11 according to one embodiment of the present invention.

FIG. 16 is a perspective view of the first compartment sealing attachment of the sealing system of the apparatus of FIG. 11 according to one embodiment of the present invention.

FIG. 17 is a side view illustrating one embodiment of a baby bottle according to the present invention.

FIG. 18 is a cutaway view illustrating one embodiment of the baby bottle of bottle FIG. 17 according to the present invention.

FIG. 19 is a cutaway perspective view illustrating the sealing system the baby bottle of FIG. 17 according to one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The baby bottle is designed to store, separate, unite, and deliver children's nutrition such as baby formula, as known to one skilled in the art.

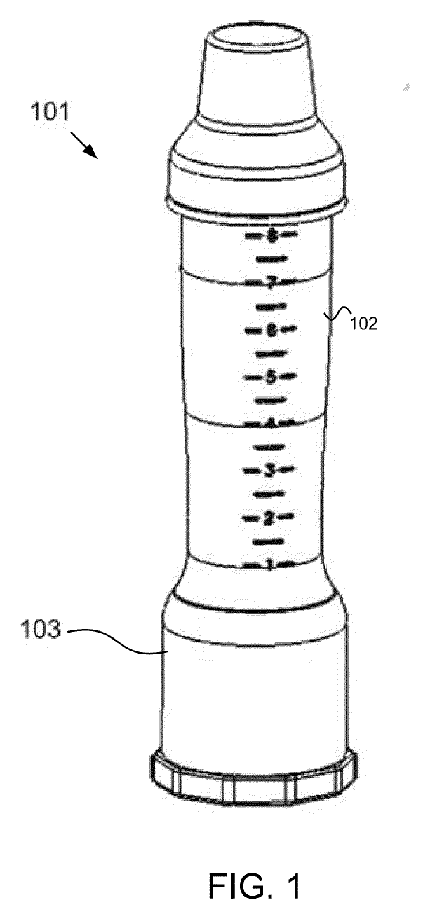

FIG. 1 depicts an embodiment of a baby bottle 101 comprising of a first compartment 102 configured to store a liquid, and a second compartment 103 configured to store a solid. Alternative configurations of the compartment 102, may not be limited to a cylinder, but may take the form of any extruded polygon as known to one skilled in the art. The second compartment 103, in certain embodiments, is configured to store a solid. The second compartment 103 can also be configured to accept the solid in various forms such as, but not limited to powder, pressed powder, and disposable powder cartridges as known to someone skilled in the art. In one embodiment the second compartment 103 may be configured to store liquid and the first compartment 102 may be configured to store a solid.

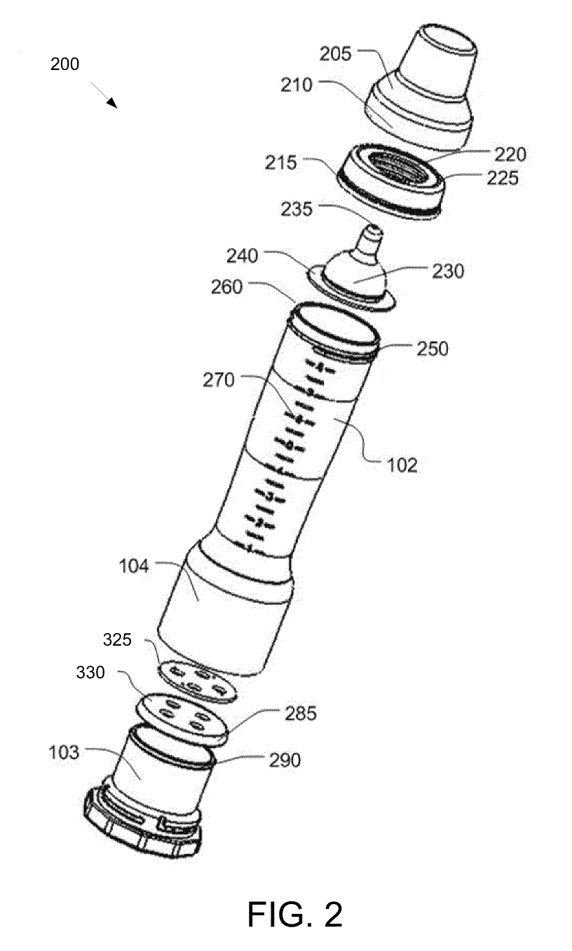

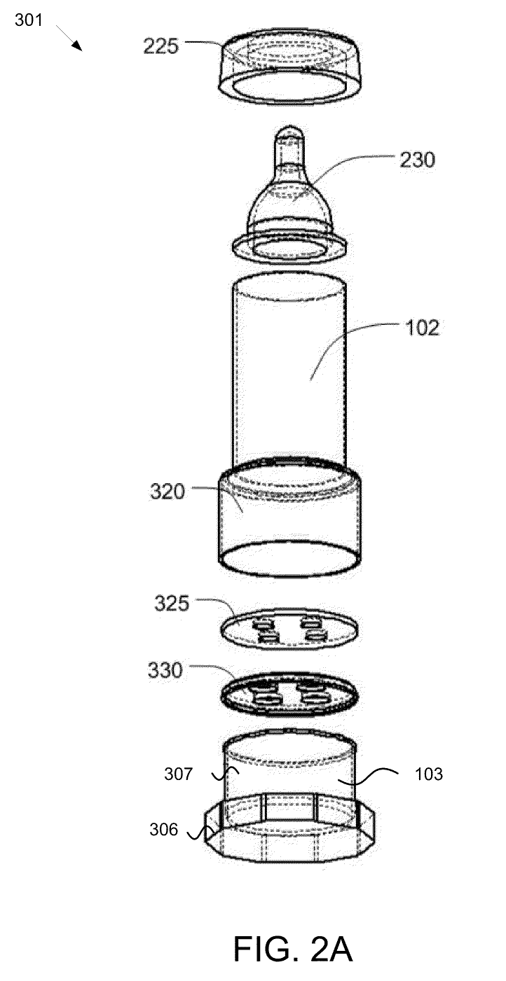

Referring to FIG. 2, an embodiment of a two-compartment baby bottle 200 according to the present invention comprises a lid 205, a retention ring 225, a nipple 230, a first compartment 102, a second compartment 103, and a bottom section 104 of the first compartment 102.

The lid 205 is configured to be placed adjacent to the retention ring 225 and selectively joined to the retention ring 225 by manually manipulating a retention snap ring 210 of the lid 205 over a retention snap ring 215 of the retention ring 225. The diameter of the retention snap ring 210 of the lid 205 is of sufficient diameter to ensure that it can be manually manipulated over the retention snap ring 215 of the retention ring 225, but small enough to ensure that once the snap retention ring 210 of the lid 205 is placed over the snap retention ring 215 of the retention ring 225 it cannot be unintentionally removed.

A nipple 230 with a nipple passage 235 is disposed through the center of the retention ring 225. Also, a nipple base 240 is disposed on the nipple 230 as shown, and is configured as a seal between the top edge 260 of the first compartment 102 and the retention ring 225. In certain embodiments the lid 205 is configured to hide the nipple 230 from view and seal the nipple passage 235 from contact with the surrounding environment for hygiene and aesthetic purposes. The nipple 230, with its passage 235 is configured to be firmly seated against the top of the lid 205 thus closing and sealing the nipple passage 235.

A threaded inclusion 220 is disposed on the inside of the retention ring 225 and is configured to be the same size and pitch as a threaded inclusion 250 on a top edge 260 of the first compartment 102. The retention ring 225 may be configured in a variety of ways to attach and seal the nipple 230 to the top edge 260 of the first compartment 102. One skilled in the art may not use threaded inclusions, but may choose to use other means such as friction or snap rings. In certain embodiments the nipple 230 may be permanently attached to the top edge 260 of the first compartment 102 by means of molding the entire assembly, welding the individual pieces together, or joining the individual pieced by a chemical bond.

In one embodiment, a plurality of volume indicator marks 270 are disposed on the first compartment 102. The volume indicator marks 270 may be alternatively configured to represent various forms of volume indication. The volume indicator marks 270 may be configured to represent volume using the metric system, the Imperial system, or other systems known in the art. In one embodiment the volume indicator marks 270 may represent a percentage of volume available or consumed from the first compartment 102.

In certain embodiments the baby bottle 200 may include a membrane plug 325 and a membrane 330 disposed between the first compartment 102 and a second compartment 103. In the embodiment illustrated in FIG. 2 the membrane plug 325 is a disc. In other embodiments the membrane plug 325 can be configured in any shape suitable to fit inside of the bottom section 104 of the first compartment 102 and form a functional seal with a membrane 330. A retention ridge 290 is disposed on a top edge of the second compartment 103 and is configured to engage a retention lip 285 on the membrane 330. In the current embodiment, the retention lip of the membrane 330 is configured to span securely around the retention ridge 290 of the second compartment 103, however, one skilled in the art can mate the second compartment 103 and the membrane 330 in various ways. The membrane 330 and second compartment 103 can be joined by mechanical means such as described in the current embodiment. In another embodiment the membrane 330 and second compartment 103 may be joined by threads (not shown) on the membrane 330 received on the threads (not shown) located on the top end of the second compartment 103. In one embodiment the membrane 330 and the second compartment 103 may be a single joined unit that is not end user serviceable such as where the two are presented as a complete system pre filled with the baby formula. For example, in certain embodiments the second compartment 103 including a membrane 330 permanently sealed to the second compartment may be offered as a complete system containing a premeasured amount of baby formula. This complete system can be referred to as a cartridge and be considered disposable by the end user of the bottle assembly. A removable seal (not shown) may be attached to the membrane 330 by a removable adhesive. The removable seal (not shown) seals the top of the membrane 330 to contain the formula within the second compartment 103. The cartridge may be used by the end user as a premeasured cartridge for quickly mixing the baby formula with water or other liquid contained within the first compartment 102.

FIG. 2A depicts an embodiment of a baby bottle 301. The baby bottle 301 includes a retention ring 225, a nipple 230, a first compartment 102, a bottom section 104 of the first compartment 102, a membrane plug 325, a membrane 330, and a second compartment 103. The first compartment 102 according to the current embodiment is cylindrical in nature. The first compartment 102 can be represented in a variety of ways such that would help the child better manipulate the apparatus. The surface of the first compartment 102 may contain various inclusions, bumps, and displacements or surface inclusions as described below. These inclusions, bumps, and displacements or surface inclusions may be configured to be integral to the first compartment 102, however, one skilled in the art may choose to configure them as a veneer, an overlay, a cover, or a new surface configured to be a removable or a non-removable surface that covers the first compartment 102. In certain embodiments the surface of the first compartment may include a soft rubber-like compound to aid in grasping the first compartment 102. The base 306 of the second compartment 103 as indicated according to the current embodiment is configured to be an extruded polygon. One skilled in the art may choose to configure the base 306 in a variety of ways as to better help the user hold and manipulate the apparatus. The base 306 may be configured to be round and cylindrical, similar to the main section 306 of the second compartment 103. The base 306 may include a veneer, an overlay, a cover, or a new surface to provide a texture for grasping the base 306. In certain embodiments the veneer, overlay, or new surface may be a removable to assist in cleaning the veneer, overlay, or new surface or base 306. In one embodiment the surface of the base 306 might include a soft rubber-like compound as to assist the user in the manipulation and activation of the baby bottle 301 as further discussed below. Where the base 306, a soft rubber-like compound may be particularly useful in assisting the user in grasping the base 306.

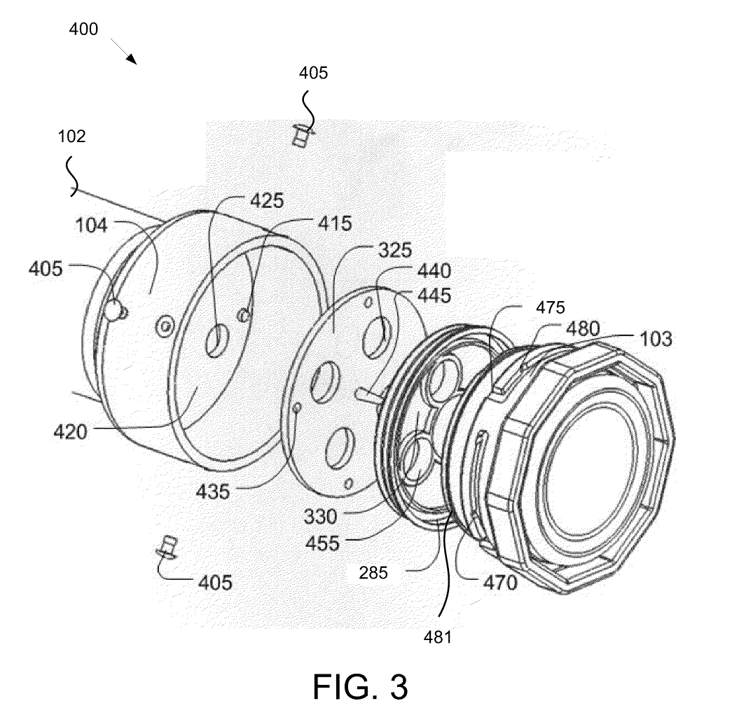

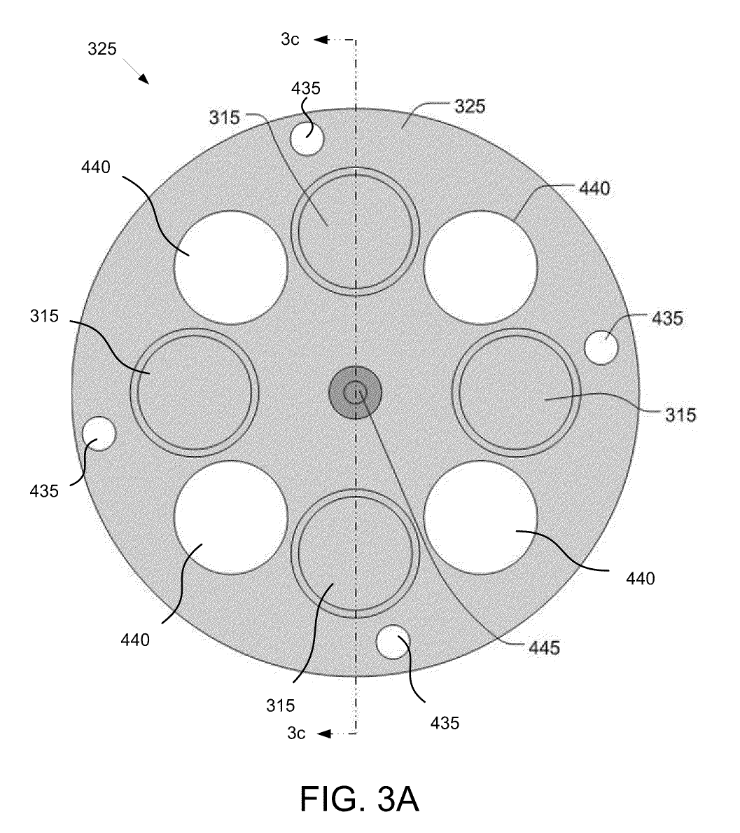

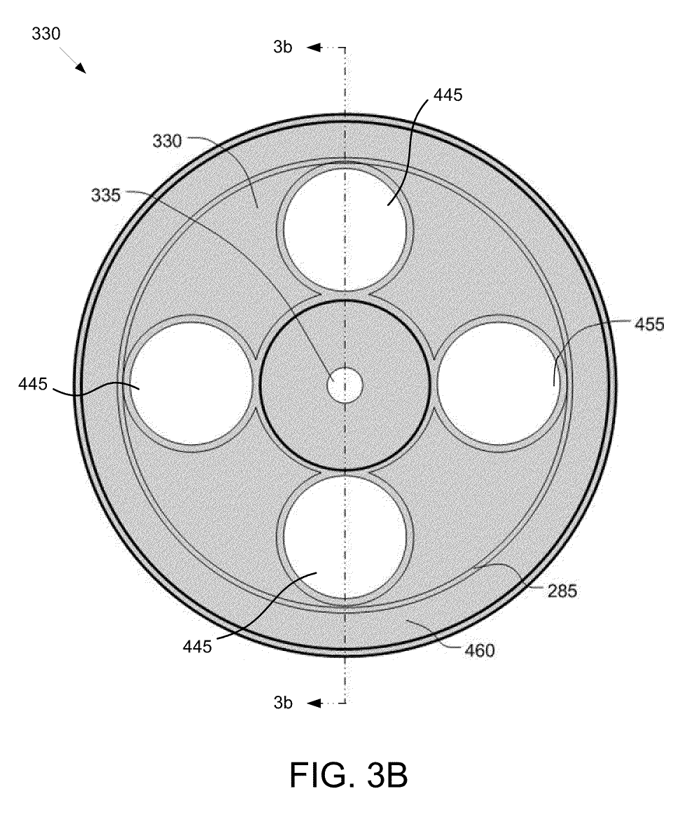

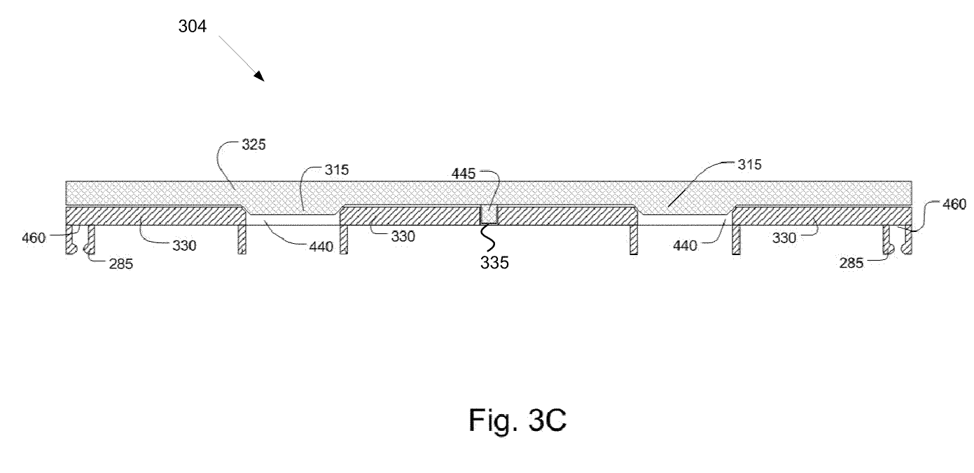

FIG. 3 depicts an exploded view of one embodiment of the lower section of a sealing system 400 for mixing infant formula. The sealing system 400 includes a first compartment 102, a second compartment 103, a membrane plug 325, and a membrane 330. The sealing system 400 may be used with a baby bottle such as baby bottle 200 and baby bottle 301 described in the embodiments above.

The first compartment 102 includes at least one alignment pin 415 located on a bottom wall or blocking wall420 of the first compartment 102. The bottom wall or blocking wall420 is positioned within a recess in the bottom of the first compartment 102. The bottom wall or blocking wall420 includes at least one passage 425 that permits material such as baby formula or water to pass through the at least one passage 425 when the sealing system 400 is activated to allow communication between the first compartment and the second compartment. When the sealing system 400 is activated, as described below, the passages 425 in the bottom wall or blocking wall 420 aligns with corresponding openings 455 in the membrane 330 allowing material such as baby formula or water to pass between the first compartment 102 and the second compartment 103. The passages 425 in the bottom wall or blocking wall420 according to the current embodiment are represented as being circular. In other embodiments the passage 425 may be any other geometric shape.

The membrane plug 325 includes a plurality of alignment holes 435 that accept the alignment pins 415 in the bottom wall or blocking wall 420 to maintain the position of the membrane plug 325 with reference to the bottom wall or blocking wall420 in the first compartment 102. The alignment pins 415 are positioned to align the at least one passage 425 in the bottom wall or blocking wall420 with passages 440 in the membrane plug 325.

The membrane plug 325 includes a rotation pin 445 positioned in the center of the membrane plug 325 and extending away from a surface of the membrane plug 325. A membrane 330 disposed between the membrane plug 325 and the second compartment 103 includes a rotation pin receiving hole (not shown) for receiving the rotation pin 445. In operation, the membrane 330 rotates around the rotation pin 445 to align openings 455 in the membrane 330 with the passages 440 in the membrane plug 325. In certain embodiments the membrane 330 includes a retention lip 285 configured to receive a top edge of the second compartment 103 to connect the membrane 330 to the second compartment 103. In one embodiment the membrane 330 is fixedly positioned on the second compartment 103 to avoid rotation of the membrane 330 when the second compartment 103 is rotated to align the openings 455 in the membrane 330 with the passages 440 in the membrane plug 325. In one embodiment the membrane 330 and/or the membrane plug 325 is made of a sealing material that seals against any leaks when the openings 455 in the membrane 330 are not aligned with the passages 440 in the membrane plug 325. In one embodiment the membrane 330 is made of a material having sufficient rigidity to maintain a vertical and lateral rigidity of the membrane 330 when the second compartment 103 is rotated with respect to the first compartment 102. The vertical and lateral integrity of the membrane 330 may aid in keeping a seal between the membrane 330 and the membrane plug 325 to maintain separation of the two substances contained in the first compartment 102 and the second compartment 103 until activation is desired.

The sealing system 400 includes a plurality of retaining pins 405 configured to be disposed through the bottom section 104. In certain embodiments the retaining pins 405 may be integrally molded in the recess in the bottom section 104 of the first compartment 102. The sealing system 400 also includes a plurality of alignment grooves 470, a plurality of alignment entrance grooves 475, and a plurality of inhibiting inclusions 480. The alignment entrance grooves 470 accept the pins 405 such that the pins 405 slide into the alignment entrance grooves 470. As the second compartment 103 is rotated with respect to the first compartment 102, the pins 405 maintain the vertical disposition of the second compartment 103 with respect to the second compartment 103. Once the pins 405 encounter an inhibiting inclusion 480 the inhibiting inclusion 480 inhibit further rotation of the second compartment 103 with respect to the first compartment 102. Additional rotational force applied to the second compartment 103 will cause the pins 405 to be dislodged from the inhibiting inclusions 480 allowing additional rotation of the second compartment 103 with respect to the first compartment 102.

FIG. 3A depicts a bottom view of the membrane plug 325. The membrane plug 325 is dissected by a cross section line 3c. The membrane plug 325 includes a plurality of plug inclusions 315, a plurality of alignment holes 435, a plurality of passages 440, and a rotation pin 445. The membrane plug 325 operates in connection with the membrane 330 to alternately open and close communication between the first compartment 102 and the second compartment 103 through passages 440 in the membrane plug 325 and the openings 455 in the membrane 330. The plug inclusions 315, as discussed below in relation to FIG. 3C, are sized to be received within the openings 455 in the membrane 330. The alignment holes 435 receive alignment pins 415 in the bottom wall or blocking wall420 of the first compartment 102. The alignment holes 435 align passages 425 in the bottom wall or blocking wall 420 of the first compartment with passages 440 in the membrane plug 325. The rotation pin 445, as discussed below in relation to FIG. 3B, is sized to be received within a rotation receiving pin hole 335 in the membrane 330 allowing the membrane 330 to rotate around the rotation pin 445.

FIG. 3B depicts a bottom view of the membrane 330. The membrane 330 is dissected by the cross section line 3b. The membrane 330 includes a plurality of membrane openings 455, a membrane retention channel 460, a rotation pin receiving hole 335, and a retention lip 285. As discussed above, the membrane openings 455 of the membrane 330 operate in connection with the passages 440 in the membrane plug 325 to alternately open and close communication between the first compartment 102 and the second compartment 103 through passages 440 in the membrane plug 325 and the openings 455 in the membrane 330. The rotation pin receiving hole 335 in the membrane 330 receives the rotation pin 445 in the membrane plug 325 and allows the membrane 330 to rotate around the rotation pin 445.

The retention channel 460 is sized to receive the top end of the second compartment 103. The retention lip 285 engages a groove 481 (FIG. 3) on the second compartment 103 to affix the membrane 330 to the second compartment 103. In certain embodiments the retention channel 460 may include threads (not shown) to affix the membrane 330 to the top end of the second compartment 103. In another embodiment the top end of the second compartment 103 may be permanently affixed within the retention channel 460. In one embodiment the membrane 330 and the second compartment 103 may be molded or created as a single integral unit.

FIG. 3C depicts an assembly 304 of the a cross section of membrane plug 325 taken along line 3c and a cross section of the membrane 330 taken along line 3b according to one embodiment of the current invention. The assembly 304 includes the membrane plug 325 and the membrane 330, with the membrane plug 325 being disposed superior and adjacent to the membrane 330. The rotation pin 445 of the membrane plug 325 is received within the rotation pin receiving hole 335 in the membrane 330. In certain embodiments the rotation pin 445 may be positioned along a common axis with the first compartment 102 and the second compartment 103. In another embodiment the rotation pin 445 and the rotation pin receiving hole 335 may be omitted and the alignment of the second compartment 102 within the bottom section 104 of the first compartment 102 may operate to align the membrane plug 325 and the membrane 330. In embodiments where the assembly 304 includes a rotation pin 445, the rotation pin 445 may be configured to be of varying length and thicknesses.

The plurality of the membrane passages 440, the membrane retention channel 460, the retention lip 285, and the plurality of membrane passage walls 455 are circular and plural in nature. Other embodiments may include membrane passages 440, a membrane retention channel 460, a retention lip 285, and the plurality of membrane passages 455 that are squares, rectangles, or other various polygons. In the embodiment illustrated in FIG. 3C the membrane 330 has been rotated to a position wherein the plug inclusions 315 of the membrane plug 325 are positioned within the membrane passages 440 of the membrane 330. In one embodiment the plug inclusions 315 are raised with respect to the surface of the membrane plug 325 that comes in contact with the membrane 330. In one embodiment, such as the embodiment illustrated in FIG. 3A the raised portion of the plug inclusions 315 comprises a raised circular surface. In another embodiment the raised portion of the plug inclusion 315 may be substantially the same shape and dimension as the membrane passages 440 such that the plug inclusions 315 are received within the membrane passages 440. In certain embodiments, such as the embodiment illustrated in FIG. 3A, only a portion of the plug inclusions 315 are raised with respect with respect to the surface of the membrane plug 325 that comes in contact with the membrane 330.

FIG. 4 depicts an apparatus 500 for mixing infant formula according to one embodiment of the present invention. The apparatus 500 includes a first compartment 102, a second compartment 103, a bottom section 104 of the first compartment 102, a plurality of rotational position indicators 515 located on a base 306 of the second compartment 103, and at least one rotational position indicator 510 located on the bottom section 104 of the first compartment 102. In certain embodiments the rotational position indicator 515 located on the base 306 is an arrow pointing towards the first compartment 102. The rotational position indicators 510 on the bottom section 104 of the first compartment may include arrows pointing towards the base 306. In certain embodiments the rotational position indicators 510 and 515 may be configured to signal the rotational position of the membrane passages 440 with respect to the position of the openings 455 in the membrane 330. When the rotational position indicator 515 on the base 306 is aligned with the rotational position indicator 510 on the bottom section 104 of the first compartment 102 marked store, the plug inclusions 315 of the membrane plug 325 are positioned within the membrane passages 440 of the membrane 330 to stop any flow of material such as water or infant formula between the first compartment 102 and the second compartment 103. When the rotational position indicator 515 on the base 306 is aligned with the rotational position indicator 510 on the bottom section 104 of the first compartment 102 marked feed, the openings 455 in the membrane 330 are aligned with the passages 440 of the membrane plug 325 and material such as water or infant formula can freely flow between the first compartment 102 and the second compartment 103. In certain embodiments the rotational position indicators 510 and 515 may be reversed such that the base 306 includes more than one rotational position indicator 515 and the bottom section 104 of the first compartment 102 includes more than one rotational position indicator 510. One skilled in the art can represent the rotational position indicators 510 and 515 as a dot, a line, or various other marks, symbols, inclusions, or formations such that the lateral position of the membrane passages 440 relative to the first openings 455 is clearly communicated to the user.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

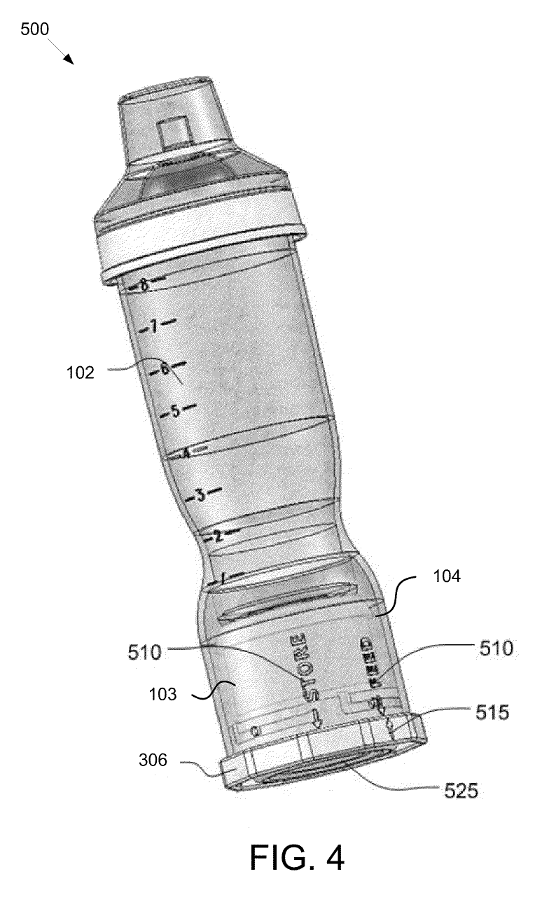

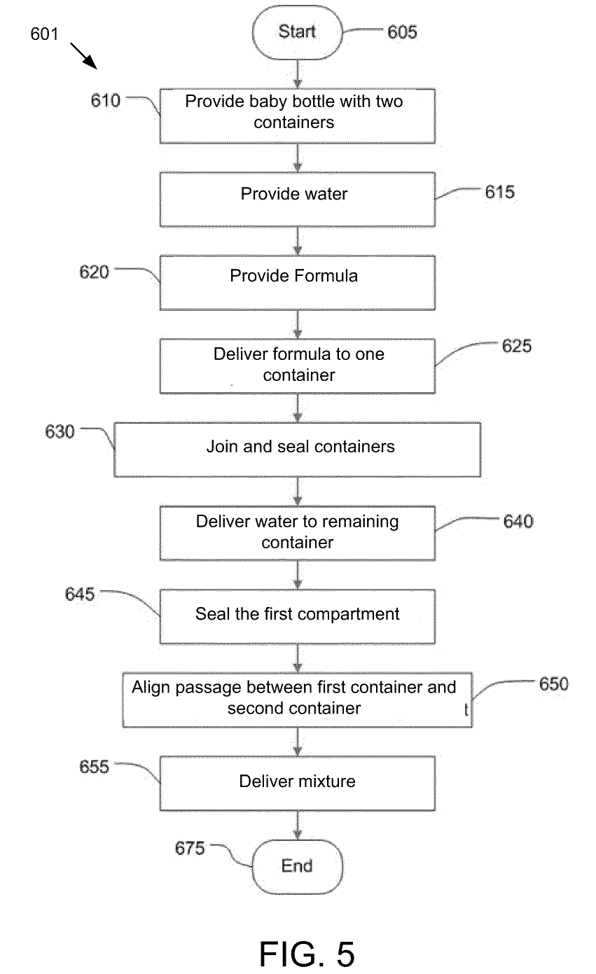

FIG. 5 illustrates an embodiment of a method 601 of storing, mixing two substances, and delivering the mixed product to a child in accordance with the present invention. The method 601 begins and a baby bottle including a first compartment 102 and as second compartment 103, as described above, is provided 605. Water is provided 615 for mixing with a baby formula. Baby formula is also provided 620. The baby formula is delivered 635 into one the first compartment 102 and the second compartment 103 in a desired amount typically the second compartment 103. One of skill in the art will recognize that in certain embodiments the baby formula may be delivered 625 into the first compartment 102. The first compartment 102 and the second compartment 103 are joined and sealed 630 with the membrane 330 and the membrane plug 325 sandwiched between the first compartment 102 and the second compartment 103. In certain embodiments the first compartment 102 and the second compartment 103 may be rotated to a position in which the plug inclusions 315 of the membrane plug 325 are positioned within the membrane passages 440 of the membrane 330 to stop any flow of material such as water or infant formula between the first compartment 102 and the second compartment 103. Water is delivered 640 in the desired amount to the remaining compartment 102 or 103, typically the first compartment 102. In embodiments where the baby formula is delivered 625 into the first compartment 102, the water may be delivered 640 into the second compartment 103. The nipple 230 and the nipple-retaining ring 225 are attached 645 the to the first compartment 102 effectively sealing first compartment 102. In certain embodiments a lid 205 may be placed over the nipple 230 for storage. The lid 205 may be configured to fit tightly over the nipple to seal the nipple passage 235 for storage of the baby bottle.

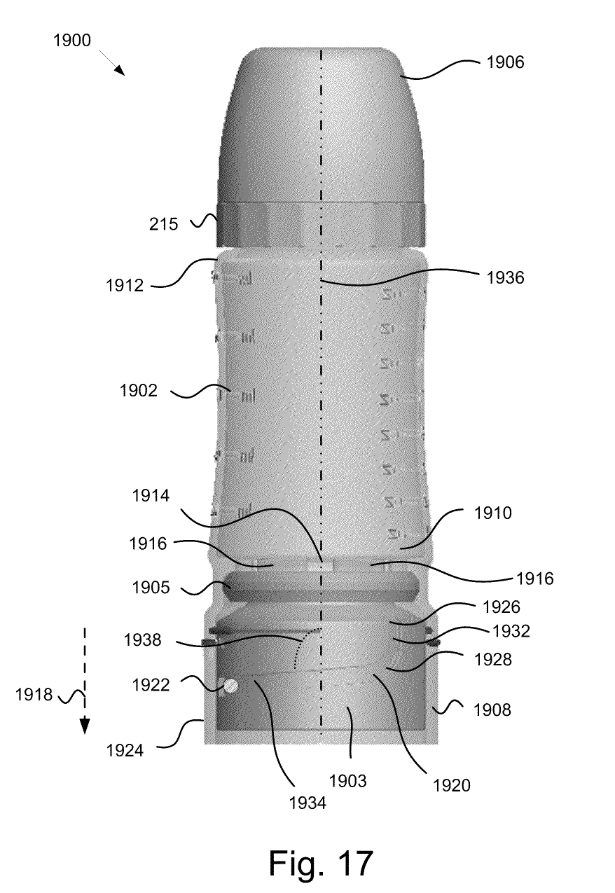

Once fluid communication is desired, a passage is opened 650 between the two compartments and the formula is allowed to mix with the water to create a formula mixture. In certain embodiments the passage may be opened by using a lateral motion or by rotating the second compartment 103 relative to the first compartment 102 to align the membrane passage 440 in the membrane 330 with openings 455 in the membrane plug 325 in a manner discussed above. In other embodiments the passage may be opened by vertical displacement of a seal that seals the passage between the two compartments 102 and 103 as described below. The resulting formula mixture is then delivered 655 to the child and the method 601 ends 675. In embodiments where a seal is vertically displaced from a passage in the bottom wall or blocking wall, as described below, a rotational force may be applied to the second compartment with respect to the first compartment to displace the seal from the passage in the bottom wall or blocking wall of the first compartment. An apparatus for vertically displacing a seal from a passage in a bottom of a first compartment by rotating the second compartment with respect to the first compartment is described in the embodiments discussed below with respect to FIGS. 17-19. One of skill in the art will recognize that the system, method and apparatus described herein are not limited to selectively mixing and delivering infant formula. As such, the system, method and apparatus described herein may used in any embodiment where the selective mixture of two substances, liquid or solid, is desired.

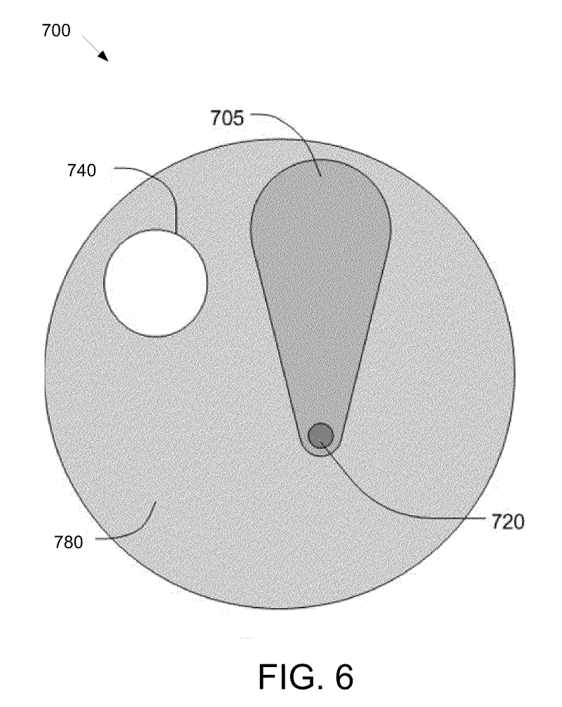

FIG. 6 depicts an embodiment of a sealing system 700 for use with a two compartment apparatus as described in the embodiments above. In certain embodiments the sealing system 700 may be used in place of the membrane 330 and the membrane plug 325 to separate the first compartment 102 from the second compartment 103 and to selectively allow communication between the first compartment 102 and the second compartment 103.

The sealing system 700 may include, in one embodiment, a membrane 780, at least one membrane passages 440 disposed through the membrane 780, a membrane plug 705, and a membrane plug pivot 720. The membrane pivot 720, in one embodiment, is positioned in substantially the center of the membrane 780 and provides a pivot about which the membrane plug 705 rotates. In other embodiments the membrane pivot can be positioned at another area on the membrane 780. In certain embodiments the membrane 780 may be attached to or engage the first compartment 102 and the membrane plug 705 may be attached to or engage the second compartment 103. In another embodiment the membrane plug 705 may be attached to or engage the first compartment 102 and the membrane 780 may be attached to or engage the second compartment 103. Regardless of the configuration, the engagement of the membrane plug 705 and the engagement of the membrane 780 operates to rotate the membrane plug 705 with respect to the membrane 780 when the first compartment 102 is rotated with respect to the second compartment 103. In certain embodiments the size, quantity, location, and disposition of the membrane plug 705, the membrane passage 740, as well as the membrane pivot plug 720 on membrane 780 may be arranged to provide a maximum volume of communication of water and formula when the apparatus is activated. In another embodiment a plurality membrane passages 740 may be sealed by a plurality of membrane plugs 705.

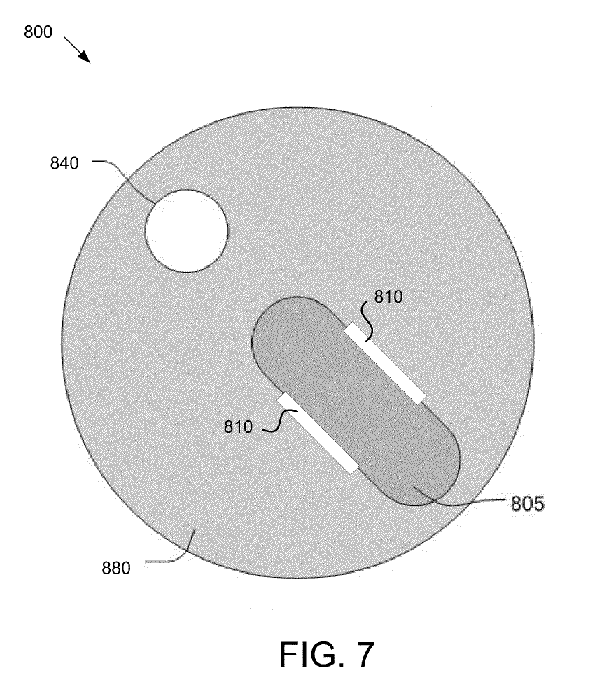

FIG. 7 depicts another embodiment of a sealing system 800 for use with a two compartment apparatus as described in the embodiments above. In certain embodiments the sealing system 800 may be used in place of the membrane 330 and the membrane plug 325 to separate the first compartment 102 from the second compartment 103 and to selectively open a passage between the first compartment 102 and the second compartment 103.

The sealing system 800 includes a sliding membrane plug 805, a membrane 880, retention flanges 810, and a membrane passage 840. The membrane plug 805 is positioned adjacent the membrane 880 and held in a position sufficiently close to the membrane 880 to seal the membrane passage 840 when the membrane plug 805 is slid laterally over the membrane passage 840. In one embodiment the membrane plug 805 may be sized such that a portion of the membrane plug 805 extends past the side of the first container 102 or second container 103 such that the membrane plug 805 can be manually manipulated to from the exterior of the first container 102 or second container 104 to slide the membrane plug 805 from a first position in which the membrane plug covers the membrane passage 840 to a second position in which the membrane plug 805 does not cover the membrane passage 840. In this manner the membrane passage 840 can be selectively opened or closed to allow communication between the first container 102 and the second container 103 to mix the materials contained with each container. In certain embodiments the membrane passage 840 and membrane plug 805 can be configured in size, shape, quantity and location to maximize the flow of fluid and powder baby formula through the passage 840.

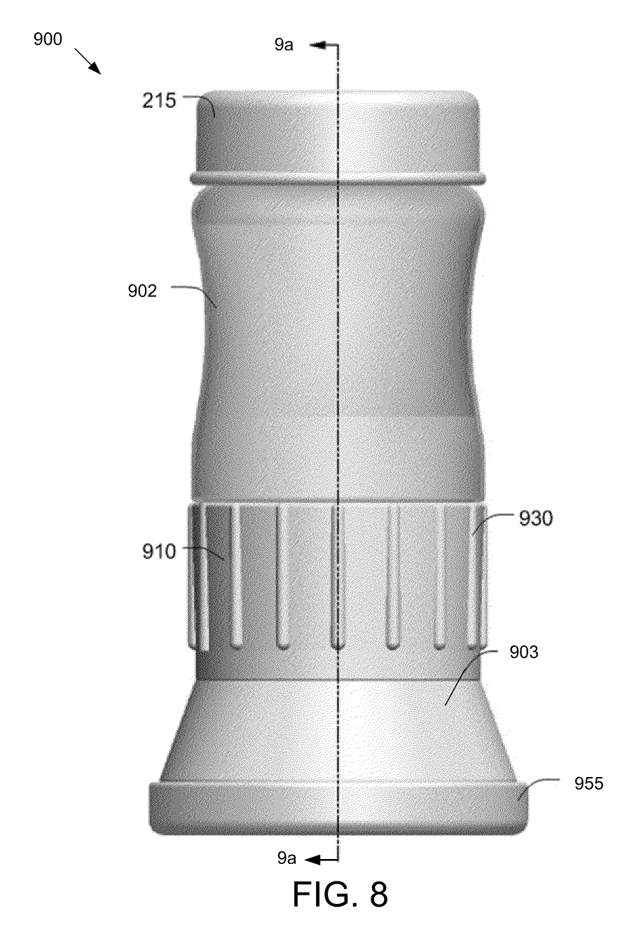

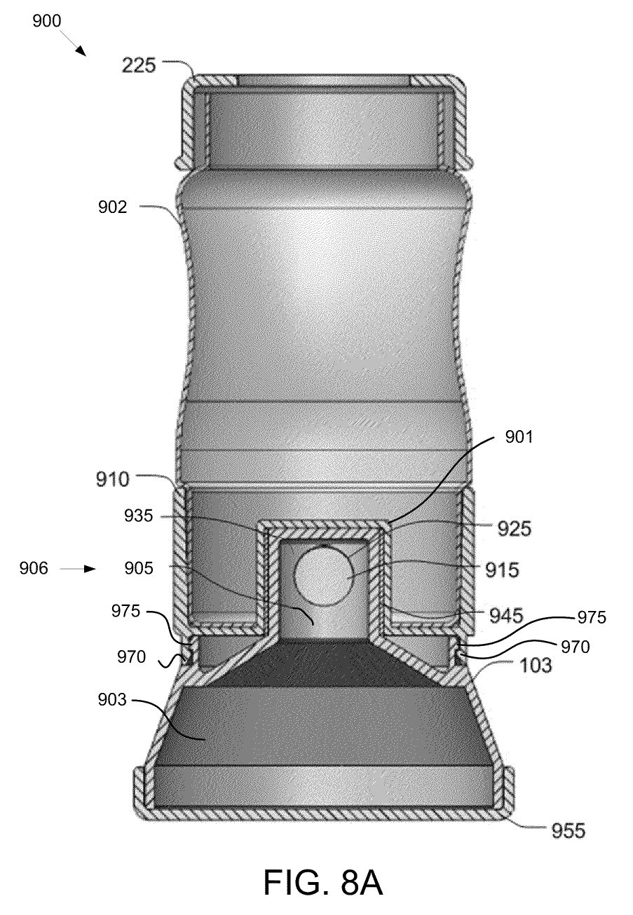

FIG. 8 depicts an apparatus 900 for mixing an infant formula according to one embodiment of the present invention. The apparatus 900 includes a nipple retention ring 215, a first compartment 902, a second compartment 903, an attachment 910, a plurality of surface area modification inclusions 930, and a base 955.

In certain embodiments the nipple retention ring 215 is substantially similar to the nipple retention ring 215 described in the above embodiments. The nipple retention ring 215 may be configured to engage threads on the top end of the first compartment 902 to hold a nipple on the top of the first compartment 902.

The first compartment 902 comprises a container for containing a liquid or solid substance. In certain embodiments the first compartment may be hourglass shaped to provide an area of decreased diameter to aid in grasping the first container 902. In one embodiment the first container 902 may be made of a translucent material such that the level of material, such as a formula mixture or water, may be easily observed through the first container 902.

The second container 903, in certain embodiments, may be substantially wider at the bottom of the second container 903 than at the top of the first container 902. Such an embodiment allows a shorter second container 903 than would otherwise be possible. In one embodiment wider bottom of the second container 903 may aid in maintaining an upright position of the apparatus 900.

The attachment 910 is configured to attach the second compartment 903 to the first compartment 902 as further described below. In certain embodiments the attachment 910 may be an item that is separately molded and then attached to the first compartment 902. Separately molding the attachment ring may aid in the manufacturing of the apparatus 900 in terms of cost of manufacturing.

The plurality of surface area modification inclusions 930 disposed on the attachment ring assist the user in applying torsional or rotational manipulation of the first compartment 102 in relation to the second compartment 103. The plurality of surface area modification inclusions 930 might be configured to best assist the user in the manipulation of the first compartment 102 in relation to the second compartment 103 in a way that will function when the plurality of surface area modification inclusions 930 are wet or dry. The plurality of surface area modification inclusions 930 might also be configured by one skilled in the art to further comprise a veneer or coating to further assist the user in torsional or rotational manipulation. The veneer may include rubber, silicone, latex, or any other friction coefficient modifying material. This same veneer may also be attached to the plurality of surface area modification inclusions 930 by chemical or mechanical means.

The base 955 may be substantially similar to the base 306 described in the above embodiments. In the embodiment illustrated in FIG. 8 the base 955 is substantially smooth and circular. In other embodiments the base 955 may include surface inclusions similar to the surface area modification inclusions 930 on the attachment 910 that raise the surface of the base to assist in grasping the base.

FIG. 8A depicts a cross section of view of the apparatus 900 taken along line 9a of FIG. 8. FIG. 8A depicts the first compartment 902, the second compartment 903, the attachment ring 910, the nipple retention ring 225, the base 955 disposed on the bottom of the second compartment 903, a passage 925 disposed through a vertical extrusion 935 on the second compartment 903, a multi stage valve extrusion 901 located in the attachment 910, a passage 915 through the multi stage valve extrusion 901, a receiving recess 905 in the first compartment 902, and a seal 945.

As illustrate in FIG. 8A the first compartment 902 includes a receiving recess 905 for receiving the multi stage valve extrusion 901 in the attachment 910. The first compartment 902 is received within the attachment 910 with the multi stage valve extrusion 901 received within the receiving recess 905 on the first compartment 902. One of skill in the art will recognize that in certain embodiments the bottom of the first compartment 902 may be open and the attachment 810 may be configured to be received over the bottom of the first compartment 902. In such an embodiment the recess 905 may be omitted.

In certain embodiments the first compartment 902 and the attachment 910 may include opposing threads for securing the attachment 910 to the first compartment 902. In another embodiment the first compartment 902 may be attached to the attachment 910 by glue or other chemicals. In one embodiment the first compartment 902 may be plastic welded to the attachment 910 as is known in the art.

The multi stage valve extrusion 901 in the attachment 910 includes a passage 915 through which fluid or other materials may flow into or out of the first compartment 902 when the attachment 910 is positioned on the first compartment 902 with the multi stage valve extrusion 901 positioned within the receiving recess 905 or within the bottom opening of the first compartment 902.

The second compartment 903 includes a vertical extrusion 935 located at the top of the second compartment 903. The vertical extrusion 935 on the second compartment 903 is received within the multi stage valve extrusion 901 of the attachment 910. A passage 925 in the vertical extrusion 935 on the second compartment 903 aligns with the passage 915 in the multi stage valve extrusion 901 on the attachment 910 to provide communication between the first compartment 902 and the second compartment 903. In certain embodiments the multi stage valve extrusion 901 may include more than one passage 915 corresponding to more than one passage 925 in the vertical extrusion 935.

A seal 945 disposed within the multi stage valve extrusion 901 seals the area between the outside of the vertical extrusion 935 and the inside of the multistage valve extrusion 901. In certain embodiments the seal 945 may comprise a cylindrical seal having at least one hole corresponding to the passage 915 through the multi stage valve extrusion 901 in the attachment 910. The seal 945 may be affixed within the multi stage valve extrusion 901 in the attachment 910 such that the seal 945 does not move when the vertical extrusion 935 is rotated with respect to the multi stage extrusion 901. When the second compartment 903 is rotated with respect to the first compartment the vertical extrusion 935 rotates within the multi stage valve extrusion 901 misaligning the passage 925 in the vertical extrusion 935 with the passage 915 in the multi stage valve extrusion 901 effectively sealing the first compartment 902 from the second compartment 903. In one embodiment the material comprising the multi stage valve extrusion 901 and/or the material comprising vertical extrusion 935 may be chosen such that the material itself forms a seal between the multi stage valve extrusion 901 and the vertical extrusion 935. In such an embodiment the seal 945 may be omitted.

In the embodiment illustrated in FIG. 8A the attachment 910 including the passage 915 in the multi stage valve extrusion 901, and the second compartment 903 including the passage 925 in the vertical extrusion 935 form a sealing system 906 for selectively separating and mixing two substances.

Clips 970 circumvent the attachment 910 and cooperate with clips 975 which circumvent the second compartment 903 to attach the second compartment 903 to the attachment 910. The clips 970 and 975 may be structure to keep the second compartment 903 attached to the attachment 910 while still allowing the second compartment 903 to rotate with respect to the first compartment 902.

The base 955 and the nipple retention ring 225 may be configured substantially similar to the base 955 and nipple retention ring 225 described in the above embodiments.

In the embodiment illustrated in FIG. 8A, the vertical extrusion 935 of the second compartment 103 is disposed and extruded along a common axis away from the second compartment 103 and directed towards first compartment 102. To one skilled in the art it would be apparent that the configuration of vertical extrusion 935 and the multi stage valve extrusion 901 might be reversed and directed towards the second compartment 903.

One skilled in the art can configure the first compartment 102, the second compartment 103, the attachment 910, and all other related components of the apparatus such that the apparatus functions and operates in the most efficient, effective, safe, user friendly, economic, and ecological manner.

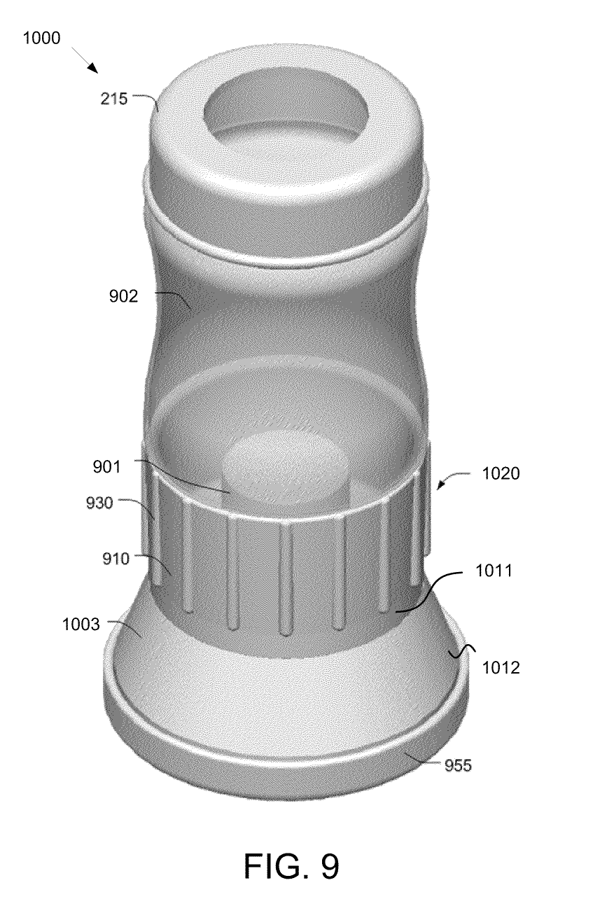

FIG. 9 depicts a top elevational view of an apparatus 1000 for selectively mixing infant formula according to one embodiment of the present invention. The apparatus 1000 includes a nipple retention ring 215 connected to a first compartment 902, a second compartment 1003, a base 955, a sealing system 1020 including an attachment 910, a surface inclusions 930 on the attachment 910, second compartment attachment 1011, and a multi stage valve extrusion 901.

The nipple retention ring 215, first compartment 902, base 955, attachment 910, surface area modification inclusions 930, and multi stage valve extrusion 901 are substantially similar to the nipple retention ring 215, first compartment 902, base 955, attachment 910, surface area modification inclusions 930, and multi stage valve extrusion 901 described above in relation to FIGS. 9 and 9A.

The second compartment attachment 1011 of the sealing system 1020 receives the second compartment 1003 in a manner substantially similar to the manner in which the attachment 930 receives the first compartment 902. Thus, in certain embodiments the second compartment 1003 is received within the second compartment attachment 1011 by physical means such as a snap fit or threads located on the inner diameter of the second compartment attachment 1011. In another embodiment the second compartment 1003 may be glued or chemically bonded within the inner diameter of the second compartment attachment 1011. One of skill in the art will recognize other means of attaching the second compartment 1003 to the second compartment attachment 1011.

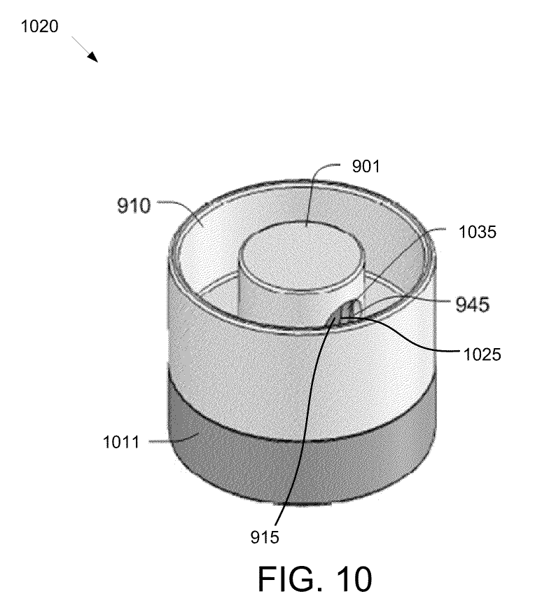

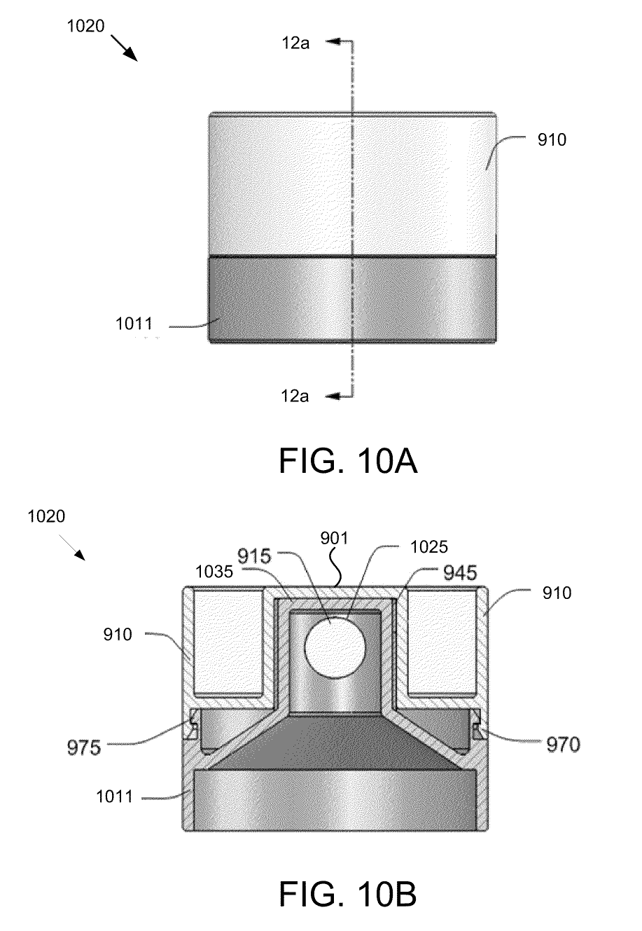

The first compartment attachment 910 and the second compartment attachment 1011 cooperate to create a sealing system 1020 discussed in further detail below in relation to FIGS. 10-10B.

The second compartment 1003, as illustrated in FIG. 9, includes a lower portion 1012 having a conical shape. In other embodiments the lower portion of the second compartment 1003 may be cylindrical or any other geometric shape. The top portion (not shown) of the second compartment 1003 may be cylindrical such that the top portion of the second compartment 1003 is received within the inner diameter of the similarly shaped second compartment attachment 1011.

FIG. 10 depicts a view of the sealing system 1020 of FIG. 9 according to one embodiment of the present invention. In operation the sealing system 1020 may operate in a manner substantially similar to the operation of the sealing system 906 discussed above in relation to FIG. 8A with the second compartment attachment 1011 having a substantially similar structure to the top end of the second compartment 903 and performing the functions of the passage 925 in the vertical extrusion 935 on the second compartment 903. As such, the second compartment attachment includes a vertical extrusion 1035 with a passage 1025 disposed through the vertical extrusion 1035. In certain embodiments a seal 945 may be positioned within the multi stage valve extrusion 901 to effectively seal the first compartment 902 from the second compartment 1003 when the passage 915 in the multi stage valve extrusion 901 is not aligned with the passage 1025 in the vertical extrusion 1035. The seal 945 includes an effective passage similar in size, displacement, as well as disposition to that of the passage 915.

One skilled in the art might configure the seal 945 to comprise a material that has a friction coefficient less than that of the material of the attachment 910 or the second compartment attachment 1011 such that the reduced coefficient of friction between the attachment 910 and the second compartment attachment 1011 reduces the torsional or rotational force required to selectively align the passage 915 with the passage 1025. The seal 945 can be configured to be removable and serviceable or replaceable by the user. The seal 945 can be configured by one skilled in the art as to be an integral and permanent fixture of the multi stage valve extrusion 901 or the vertical extrusion 1035. The seal 945 may be integrated and mated with the multi stage valve extrusion 901 or the vertical extrusion 1035 by either chemical or physical means, or a combination thereof.

FIG. 10A depicts a side view of the sealing system 1020 illustrating the attachment 910 and the second compartment attachment 1011 according to one embodiment of the present invention. As illustrated, the attachment 910 may be positioned adjacent and superior to the second compartment attachment 1011. In one embodiment the position of the attachment 910 and the second compartment attachment 1011 may be reversed such that the second compartment attachment 1011 is positioned adjacent and superior to the attachment 910. In certain embodiments the inner diameter of the attachment 910 and the inner diameter of the second compartment attachment 1011 may be substantially the same size and may be configured to attach to either the first compartment 902 or the second compartment 1003.

FIG. 10B is a cross section view of sealing system 1020 taken along line 12a of FIG. 10A. The embodiment illustrated in FIG. 10B shows the vertical extrusion 1035 with the passage 1025 disposed through the vertical extrusion 1035 of the second compartment attachment 1011 aligned with the passage 915 in the multistage valve extrusion 901 of the attachment 910. FIG. 10B further depicts the seal 945 positioned within the multistage valve extrusion 901 of the attachment 910.

Clips 970 disposed around the circumference of the attachment 910 may be configured to engage clips 975 disposed around the circumference of the second compartment attachment 1011 to hold the attachment 910 in a mating position with the second compartment attachment in a manner substantially similar to the manner that clips 970 and 975 are engaged to hold the attachment 910 of FIG. 8A in a mating position with the second compartment of FIG. 8A. One of skill in the art will recognize that attachment 910 may be held in a mating position with second compartment in other various manners without departing from the spirit of the present invention.

The clips 970 of the first attachment 910 and the clips 975 of the second compartment attachment 1011 may also be configured may also be configured in successively increasing and decreasing depths configured to accept one another to progressively form a tighter physical seal and a mechanical mate as progressive clips 970 or 975 are disposed further up or down the attachment 910 and second compartment attachment 1011.

The clips 970 of the attachment 910 and the clips 975 of the second compartment attachment 1011 as represented in FIG. 10B are configured to allow, support, and limit the inhibition of the torsional or rotational forces and resulting from lateral motion of the first compartment 902 in relation to the second compartment 1003. This allows the user to adjust the torsional or rotational forces required to operate the apparatus 900. In certain embodiments the clips 970 of the attachment 910 and the clips 975 of the second compartment attachment 1011 may be made of a material different than that of the rest of the body of the attachment 910 or the second compartment attachment 1011 to limit the coefficient of friction between the first attachment 910 and the second compartment attachment 1011 when torsional or rotational force is applied to the first compartment 902 in relation to the second compartment 1003. The material of the clips 970 of the attachment 910 and the clips 975 of the second compartment attachment 1011 may be flexible and malleable enough to allow the user to easily mate the first attachment 910 with the second compartment attachment 1011 and to limit undesired separation of the attachment 910 from the second compartment attachment 1011.

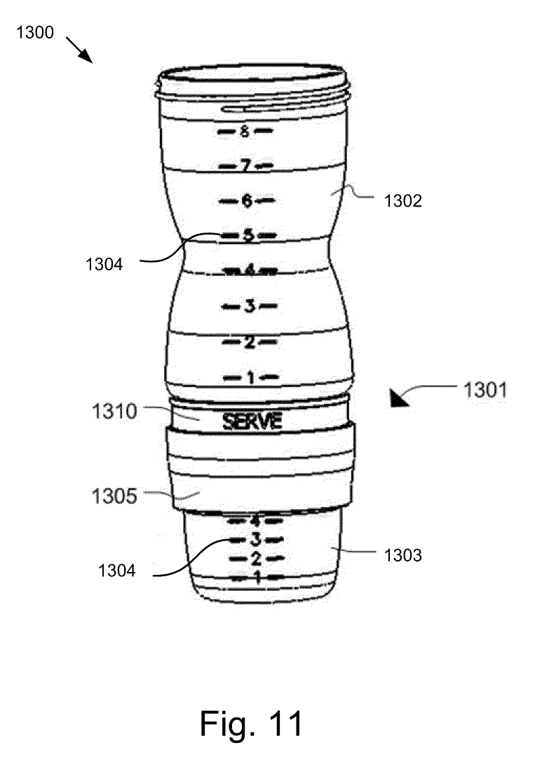

FIG. 11 depicts an apparatus 1300 for mixing an infant formula according to one embodiment of the present invention. The apparatus 1300 includes a first compartment 1302 disposed superior to a second compartment 1303 with a sealing system 1301 positioned between the first compartment 1302 and the second compartment 1303.

The first compartment 1302 and the second compartment 1303 include volume indicator marks 1304 indicating a volume of material in the first compartment 1302 and the second compartment 1303. To one skilled in the art it would be apparent that the volume indicator marks 1304 might be configured to represent absolute or relative volume. Absolute volume can comprise the Metric (systeme internationale) or the Imperial measurement system.

The sealing system 1301 may include a first compartment sealing attachment 1310 attached to the first compartment 1302 and a second compartment sealing attachment 1305 attached to the second compartment 1303. The first compartment sealing attachment 1310 of the first compartment 1302 is positioned under the first compartment 1302 and the second compartment sealing attachment 1305 positioned above the second compartment 1303. The second compartment sealing attachment 1305 and the first compartment sealing attachment 1310 are disposed adjacent to one another and are configured to interact with one another in a way to form a functional seal of between the first compartment 1302 and the second compartment 1303. The second compartment sealing attachment 1305 and the first compartment sealing attachment 1310 are configured to selectively separate by motion parallel a common axis between the first compartment sealing attachment 1305 and the second compartment sealing attachment 1310. FIG. 11 depicts the apparatus 1300 and the second compartment sealing attachment 1305 and the first compartment sealing attachment 1310 in a separated configuration wherein material in the first compartment 1302 and material in the second compartment 1303 can freely flow between the two compartments.

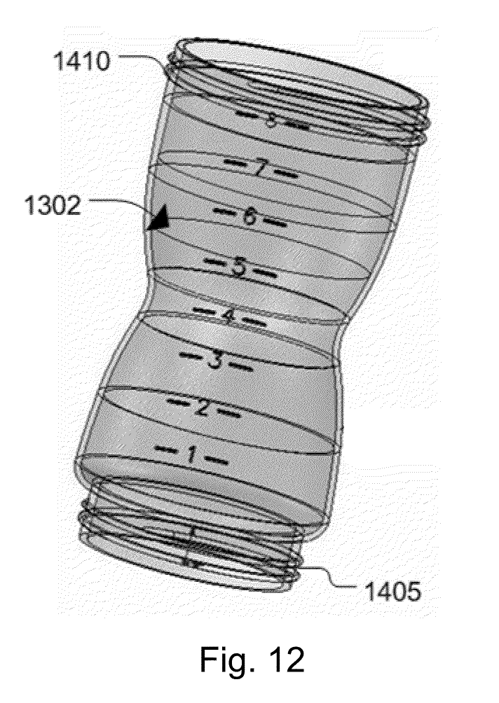

FIG. 12 depicts a view of the first compartment 1302 of the apparatus 1300 according to one embodiment of the present invention. The first compartment 1302 is designed and configured to hold a substance. The first compartment 1302 includes threads 1405 positioned at or near the bottom of the first compartment 1302. The first compartment 1302 further includes threads 1410 positioned on the top of the first compartment 1302. The treads 1405 on the bottom of the first compartment 1302 are configured to function as a retention mechanism to retain the first compartment sealing attachment 1310. In certain embodiments the threads 1405 on the bottom of the first compartment 1302 may be made of a material that is substantially different that of the rest of the first compartment 1302. For example, in certain embodiments the threads 1405 may be made of a material having an elastic property to aid in creating a watertight seal between the first compartment 1302 and the first compartment sealing attachment 1310. In another embodiment the threads 1405 on the base of the first compartment 1302 may be made of a material that is more malleable or flexible than the material of the first compartment 1302 to assist the user in attaching the first compartment 1302 to the first compartment sealing attachment 1310.

The first compartment 1302 also includes threads 1410 on the top of the first compartment 1302. To one skilled in the art is would be apparent that the threads 1410 disposed the top of the first compartment 102 are configured to function as a retention mechanism and may be used in attaching a nipple using a nipple retention ring substantially similar to the nipple retention ring 215 described in the above embodiments. The threads 1410 on the top of the first compartment 1302 may also be made of a material that is substantially different that of the rest of the first compartment 1302 to aid in sealing a nipple retention ring 215 to the first compartment or to assist a user in attaching the first compartment 1302 to the nipple retention ring 215.

The view of the first compartment 1302, as represented in FIG. 12, illustrates the first compartment 1302 as having a shape similar that of an hourglass. To one skilled in the art, it would be apparent that the shape and form of the first compartment 1302 may comprise a variety of other shapes. In certain embodiments an hourglass shape may be desirable to give the user an area of decreased diameter for grasping the first compartment 1302. The first compartment 1302 is presented in this form to assist the user in the manipulation of the device, to maximize volume, or to assist and simplify the manufacturing process. In other embodiments the shape, size, presentation, and the material of the first compartment may be altered, or adjusted to maximize volume, assist the user in the manipulation of the apparatus, increase esthetic appeal, or aid in the manufacturing of the apparatus 1400.

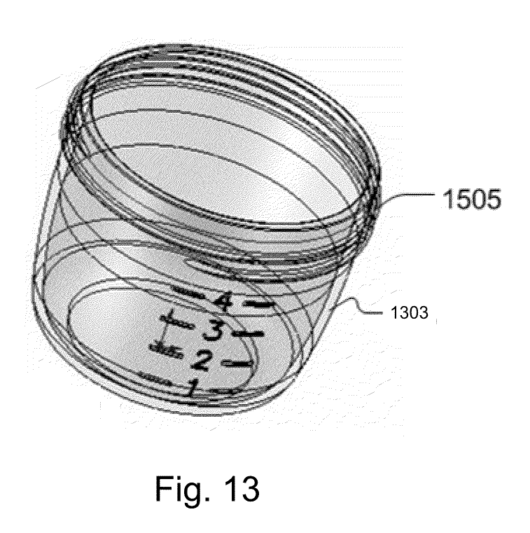

FIG. 13 illustrates one embodiment of the second compartment 1303 of the apparatus 1400 of FIG. 11. The second compartment 1303 includes threads 1505 disposed at the top of the second compartment 1303. The threads 1505 disposed the top of the second compartment 1303 may also be made of a material that is substantially different that of the rest of the second compartment 1303 to aid in sealing a the second compartment 1303 to the second compartment sealing attachment 1305 and to assist a user in attaching the second compartment 1303 to the second compartment sealing attachment 1305.

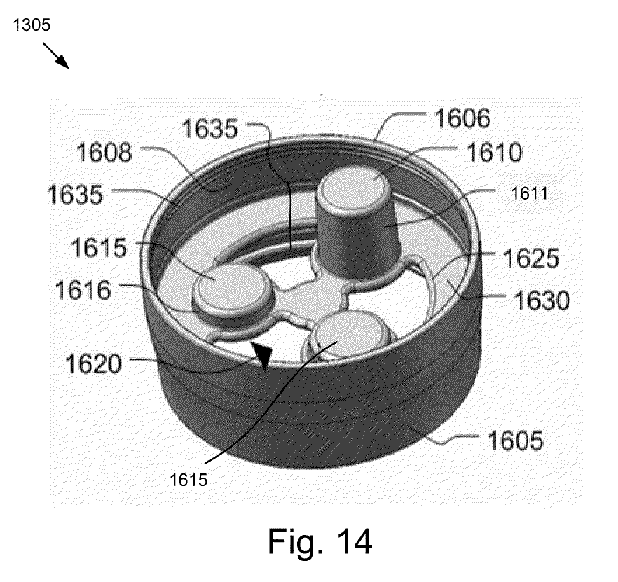

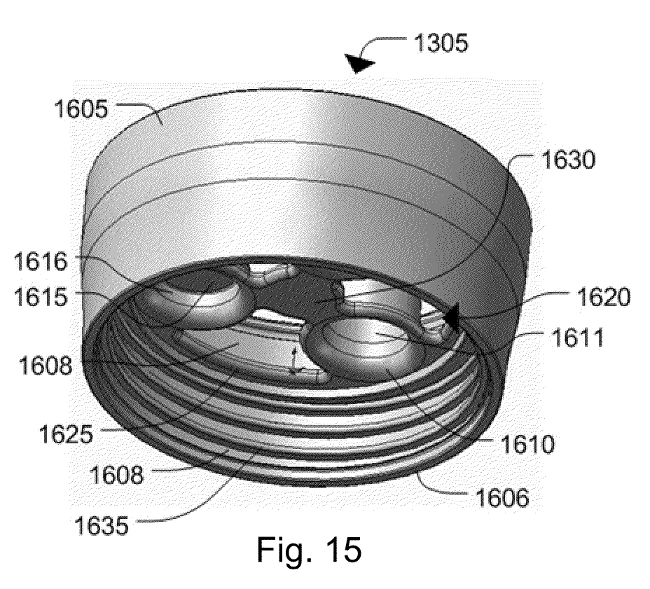

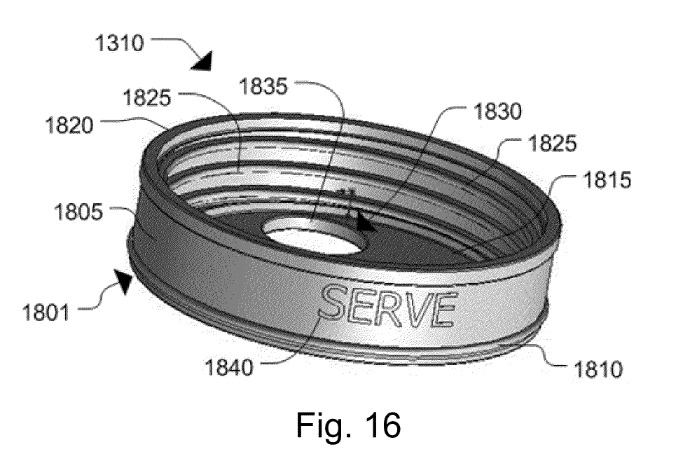

FIGS. 14, 15 and 16 illustrate one embodiment of the sealing system 1301 of FIG. 11. FIG. 14 and FIG. 15 illustrate a top perspective view (FIG. 14) and a bottom perspective view (FIG. 15) of the second compartment sealing attachment 1305 of the sealing system 1301 of apparatus 1300 according to one embodiment of the present invention. FIG. 16 illustrates a top perspective view of the first compartment sealing attachment 1310 of the sealing system 1301 of apparatus 1300 according to one embodiment of the present invention. The first compartment sealing attachment 1310 and the second compartment sealing attachment 1305 cooperate to selectively block passages disposed through the first compartment sealing attachment 1310 and the second compartment sealing attachment 1305 as further described below.

As illustrated in FIG. 14, the second compartment sealing attachment 1305 includes a flange 1605, a flange lip 1606, a flange interior wall 1608, a plurality of blocking plugs 1615, a plurality of blocking plug walls 1616, an alignment plug 1610, an alignment plug wall 1611, a plurality of lid passages 1620, a plurality of lid passage walls 1625, a lid membrane 1630, and a plurality of ridged inclusions 1635. These elements are discussed below in describing the operation of the sealing system 1301.

FIG. 15 illustrates a bottom perspective view of the second compartment sealing attachment 1305. The bottom view illustrated in FIG. 15 shows the flange 1605, the flange lip1606, the flange interior wall 1608, the alignment plug 1610, the alignment plug wall 1611, the blocking plugs 1615, the blocking plug walls 1616, the plurality of lid passages 1620, the plurality of lid passage walls 1625, the lid membrane 1630, and a plurality of ridged inclusions 1635 of FIG. 14. These elements are discussed below in describing the operation of the sealing system 1301.

FIG. 16 illustrates a view of a first compartment sealing attachment 1310 of the sealing system 1301 according to one embodiment of the present invention. The first compartment sealing attachment 1310 includes an extended flange 1801, and extended flange wall 1805, a flange ring 1810, a base membrane 1815, a flange lip 1820, a base retention ring 1825, a base passage 1835, a passage wall 1830, and a position indicator 1840.

According to the present invention, the baby bottle apparatus 1300 is configured to store a solid as well as a liquid, mix or activate the solid and the liquid, and finally deliver the resulting solution to an infant. In FIG. 11, according to the present invention, the second compartment sealing attachment 1305 is disposed superior and adjacent the second compartment 1303. The second compartment sealing attachment 1305 disposed along the common axis between the first compartment sealing attachment 1310 and the second compartment 103. The second compartment sealing attachment 1305 includes a plurality of blocking plugs 1615 that are disposed within the opening 1835 of the first compartment sealing attachment 1310 when the sealing system 1301 is positioned in a closed position. The blocking plug walls 1616 of the blocking plugs 1615 and forms an effective seal within the opening 1835 to seal the opening 1835. The blocking plugs 1615 and the openings 1835 may be configured in various geometric shapes other than the cylindrical shape illustrate in FIGS. 16-18. The blocking plugs 1615 and the openings 1835 are configured as a circle, or cylinder in the current embodiment for the purpose of maximizing area and therefore maximizing the rate of communication between the first compartment 1302 and the second compartment 1303. One skilled in the art may choose to configure the blocking plugs 1615 and the openings 1835 in any number of configurations and shapes.

To activate the sealing system 1301 to allow for communication between the first compartment 1302 and the second compartment 1303 the second compartment sealing attachment 1305 and first compartment sealing attachment 1310 are separated relatively from each other along the common axis. The blocking plugs 1615 are removed from the base passages 1835 to remove the functional seal between the blocking plug walls 1616 and the passage wall 1830.

In the closed configuration, the motion and displacement of the second compartment sealing attachment 1305 in relation to the first compartment sealing attachment 1310 is limited by the physical proximity of the base membrane 1815 with the lid membrane 1630. The alignment plug 1610 and alignment plug wall 1611 protrudes through a base passage 1830 completely and continues to be disposed further into the cavity of the first compartment 1302. The blocking plugs 1615 are shorter than the alignment plug 1610.

The vertical motion and separation of the second compartment sealing attachment 1305 in relation to the first compartment sealing attachment 1310 is effectively limited by the flange lip1606 on the interior flange wall 1608 of a flange 1605 of the second compartment sealing attachment 1305. The plurality of ridged inclusions 1635 are configured to oppose and align with a base retention ring 1825 which are disposed on the interior of the extended flange wall 1805 of the extended flange 1301 of the first compartment sealing attachment 1310. The vertical separation of the plurality of ridged inclusions 1635 and the base retention ring 1825 is such that the distance does not exceed the vertical extrusion length of the alignment plug 1610. One skilled in the art is inclined to configure the height of the alignment plug 1610 as to not exceed the vertical separation of the lid 1315 in relation to the first compartment sealing attachment 1310 for the purpose of limiting and inhibiting any rotational, angular, or torsional or rotational forces or motion of the first compartment 1302, or the second compartment 1303, or the lid 1315, or the first compartment sealing attachment 1310 relative to one another. The alignment plug 1610 is received with one of the base passages 1835 to limit rotation of the first compartment sealing attachment 1310 with respect to the first compartment sealing attachment 1305 when the first compartment sealing attachment 1310 and the second compartment sealing attachment 1305 are attached to each other.

FIG. 17 illustrates a side view of an apparatus 1900 for mixing an infant formula according to one embodiment of the present invention. The apparatus 1900 includes a first compartment 1902, a second compartment 1903, and a seal 1905 disposed between the first compartment 1902 and the second compartment 1903.

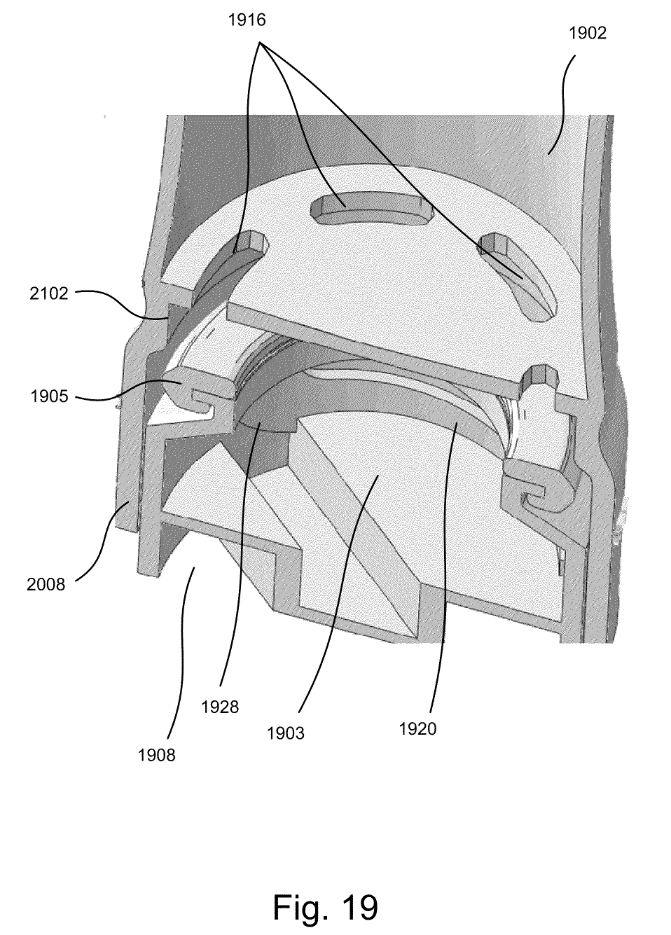

The first compartment 1902 and the second compartment receiving recess 1908 are shown as transparent in the embodiment illustrated in FIG. 19 for clarity in describing the present embodiment. One of skill in the art will recognize that in certain embodiments the first compartment 1902 and the second compartment receiving recess 1908 may be an opaque material such that the second compartment 1903 is not visible when looking at the side of the apparatus 1900. aid in understanding

In the embodiment illustrated in FIG. 17 the first compartment 1902 includes a second compartment receiving recess 1908 positioned near the bottom end 1910 of the first compartment 1902. A nipple retention ring 215 substantially similar to the nipple retention ring 215 discussed above attaches a nipple to the top end of the first compartment 1902. In certain embodiments a lid 1906 may cover the nipple to both seal the nipple and keep it clean.

The first compartment 1902 also includes a bottom wall 1914 separating the first compartment 1902 from the second compartment receiving recess 1908. The bottom wall 1914 includes at passages 1916 that allow communication between the first compartment 1902 and the second compartment 1903. In the embodiment illustrated in FIG. 19 the first compartment 1902 and the second compartment 1903 are shown in a closed configuration with the passages 1916 sealed by seal 1905. In certain embodiments the seal 1905 may be attached to the second compartment 1903 such that the seal 1905 seals the passages 1916 when the second compartment 1903 is positioned within the second compartment receiving recess 1908 to a depth sufficient to place the seal 1905 adjacent to the passages 1916. In one embodiment, additional pressure may be placed on the seal 1905 beyond a pressure sufficient to place the seal 1905 in contact with the passages 1916. In certain embodiments the seal 1905 may be made of a malleable material that deforms with pressure. In such an embodiment the malleable material of the seal may be displaced with the passages 1916 to seal the passages 1916.

To open the passages 1916, the seal 1905 is displaced from the passages 1916 in the direction indicated by arrow 1918. In certain embodiments the seal 1905 may be attached to the second compartment 1903 and may be displaced from the passages 1916 by pulling or otherwise moving the second compartment 1903 in a direction indicated by arrow 1916. In another embodiment the seal 1905 may be attached to the second compartment 1903 and may be displaced from the passages 1916 rotating the second compartment 1903 with respect to the first compartment 1902. In one embodiment the rotation of the second compartment 1903 with respect to the first compartment 1902 may cause the second compartment 1903 to withdraw from within the second compartment receiving recess 1908.

The second compartment 1903 is sized to be received within the second compartment receiving recess 1908. The second compartment 1903 may be configured to hold a solid or a liquid. In certain embodiments the second compartment 1903 is cylindrical and sealed at the bottom. A cylindrical second compartment 1903 allows the second compartment to rotate within the second compartment receiving recess 1908.

The second compartment 1903 includes at least one groove 1920 that receives corresponding pin(s) 1922 disposed on the inner surface of the second compartment receiving recess 1908. In one embodiment the pin 1922 maybe integrally molded with the second compartment receiving recess 1908 such that the material comprising the second compartment receiving recess also makes up the pin 1922. In another embodiment the pin 1922 may comprise a separate item disposed through a wall 1924 of the second compartment receiving recess 1908. Upon inserting the second compartment 1908 into the second compartment receiving recess 1908 the pin 1922 engages a section 1932 of the groove 1920 that runs substantially parallel to a common axis 1936 of the apparatus 1900. The pin 1922 enters the groove 1920 at a groove entrance 1926. As the second compartment 1903 is advanced further into the second compartment receiving recess 1908, the pin 1922 is advanced within the groove 1920 past an elbow 1928.

Once the pin 1922 is advanced to a position past the elbow 1928 in the groove 1920 the second compartment 1903 can be rotated within the second compartment receiving recess 1908 with the pin 1922 sliding through a section 1934 the groove 1920 that runs at a substantially right angle to the common axis 1936 of the apparatus 1900. In one embodiment, the section 1934 the groove 1920 that may run at an angle 1938 greater than ninety degrees with respect to the common axis 1938. In such an embodiment the second compartment 1903 may be drawn further into the second compartment receiving recess 1908 as the pin 1922 engages the groove 1920 at a progressively deeper position on the second compartment 1903. The second compartment 1903 may include a second pin (not shown) and a second groove (not shown) positioned opposite the pin 1922 and groove 1920 to balance the insertion and withdrawal of the second compartment 1903 within the second compartment receiving recess 1908. One of skill in the art will recognize that in certain embodiments the apparatus 1900 may include three or more pins 1922 and three or more grooves 1920.

While the embodiment illustrated in FIG. 17 depict a pin 1922 engaging a groove 1920, one of skill in the art will recognize that the pin 1922 and the groove 1920 may be replaced with threads on the outside of the second compartment and threads on the inside of the second compartment receiving recess 1908. In certain embodiments the pin 1922 may be a raised bump located on the inner wall of the second compartment receiving recess. Similarly, in one embodiment the pin 1922 and groove 1920 may be replaced with any mechanical mechanism that longitudinally displaces the second seal 1905 from the passages 1916 to open passages 1916 and allow fluid to flow between the first compartment 1902 and the second 1903 compartment.

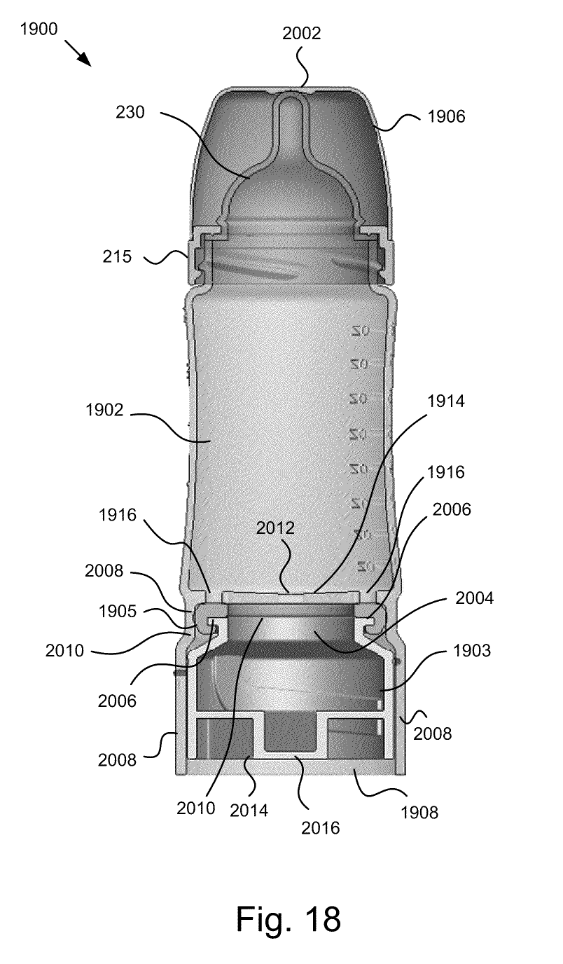

FIG. 18 illustrates a cutaway view of apparatus 1900 demonstrating the operation of the lid 1906 in sealing the nipple 230. The nipple 215 is substantially similar to the nipple 215 described in the embodiments above. The lid 1906 engages the nipple retention ring 215 such that the inside of the top of the lid 1906 substantially seals the nipple 230. In certain embodiments the lid 1906 may include a raised inclusion 2002 on the inside of the lid 1906 to aid in sealing the nipple 230. In one embodiment the raised inclusion 2002 may be shaped to include an impression that mimics the shape of the top of the nipple 230. The lid 1960 may engage the lid by threads, snap fit, or other mechanical fastening methods known in the art. In certain embodiments the nipple 230 may be omitted and the apparatus 1900 may be used with an alternative fluid delivery apparatus such as a child's sippy cup lid, a straw or other fluid delivery mechanism.

In certain embodiments the seal 1905 is toroidal such that fluid or formula can flow from the first container 1902 through passages 1916 through the opening 2004 in the seal 1905 and into the second compartment 1903 when the seal 1905 is displace away from the bottom wall of the first compartment 1902 to open passages 1916. The seal 1905 may rest on or be seated over a seal retention lip 2006 that circumvents the top of the second compartment 1903. In certain embodiments the seal retention lip 2006 may add a structure or rigidity to the seal 1905 allowing the seal 1905 to be made of a softer or more malleable material. In one embodiment a softer or more malleable seal 1905 may provide a better seal than a seal 1905 made of a harder material. The seal 1905, in certain embodiments, the seal 1905 not only seals the passages 1916 but also seals the second compartment against the inner wall 2008 of the second compartment receiving recess 1908.

In one embodiment a depression 2010 may be positioned along a section of the wall 2008 of the second compartment receiving recess 1908. The depression 2010 may limit the depth with which the second compartment 1903 can be received within the second compartment receiving recess 1908. In one embodiment the seal 1905 is seated against the inner wall 2008 of the second compartment receiving recess 1908 at a position adjacent to the depression 2010 in the wall 2008.

The top 2010 of the second compartment 1903 may be open in certain embodiments and be sealed by a center portion 2012 of the bottom wall 1914 of the first compartment 1902 when the second compartment 1903 and the first compartment 1902 are in the closed position. Once the second compartment 1903 is rotated with respect to the first compartment 1902 causing the seal 1905 to be displaced form the passages 1916 in the bottom wall 1914 of the first compartment 1902 water or other material can flow through the passages and through the opening 2004 in the top 2010 of the second compartment 1903. The bottom 2014 of the second compartment 1903 may include a handle 2016 integrally molded into the bottom 2014 of the second compartment 1903. While the embodiment illustrated in FIG. 20 depicts the handle 2016 as being integrally molded into the bottom 2014 of the second compartment 1903, one of skill in the art will recognize that in certain embodiments the handle 2016 may be an extruded component extending from the bottom 2014 of the second compartment 1903. The integrally molded handle 2016 of FIG. 20 may assist the user in rotating the second compartment 1903 with respect to the first compartment 1902 and still allow the user to place the apparatus 1900 in an upright position.

FIG. 19 illustrates a cutaway view of the seal 1905 being displaced from the passages 1916 according to one embodiment of the present invention. As illustrated, the second compartment 1903 is being inserted into the second compartment receiving recess 1908. In certain embodiments once the pin 1922 passes the elbow 1920 in the groove 1920 on the second compartment 1903, the second compartment 1903 may be positioned deep enough within the second compartment receiving recess 1908 that the seal 1905 is positioned adjacent to the flat surface 2102 on the wall 2008. This allows the second compartment 2008 to move up and down on the flat surface 2102 of the wall 2008 while still maintaining a seal between the second compartment 1903 and the wall 2008 of the second compartment receiving recess 1908.

One of skill in the art will recognize that in certain embodiments, once passage 1916 is opened by separating the seal 1905 from the passages 1916, and the water is allowed to flow from the first compartment 1903 into the second compartment 1903 to mix the infant formula, the user may shake the apparatus 1900 to create a homogeneous mixture. In one embodiment, before shaking the apparatus 1900, the seal 1905 may be re-positioned to against the passages 1916 to keep the water and the formula one of the top compartment 1902 or the bottom compartment 1903 while shaking the apparatus 1900 to mix the formula with the water or other fluid to create a homogenous mixture. In certain embodiments the apparatus 1900 may be turned over prior to mixing the two substances such that the first compartment 1902 is positioned below the second compartment 1903 and the powder formula flows from the second compartment 1903 into the first compartment 1902.

The passages 1916 may be sized and configured to allow a maximum flow of material between the first compartment 1902 and the second compartment 1903 when the seal 1905 is displaced from the passages 1916. In certain embodiments a maximized flow of material between the first compartment 1902 and the second compartment 1903 may aid in thoroughly mixing the material in the first compartment 1902 with the material in the second compartment 1903.

In certain embodiments the passages 1916 may be located in the center of the bottom wall in the first compartment 1902 with a corresponding seal 1905 positioned to selectively seal and unseal the passages 1916. In such an embodiment the material in the first compartment 1902 may enter the second compartment 1903 at an area other than the center of the second compartment 1903.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for selectively mixing multiple substances, the apparatus comprising:
a first compartment;
a second compartment;
a passage disposed between the first compartment and the second compartment; and
a seal configured to selectively block the passage.

2. The apparatus of claim 1, wherein the first compartment and the second compartment comprise a similar axis.

3. The apparatus of claim 2, wherein the first and second compartment selectively displace in relation to one another along the similar axis.

4. The apparatus of claim 1, wherein the first compartment, the second compartment, and the seal are configured to individually accept selective motion that longitudinally displaces the seal from the passage.

5. The apparatus of claim 4, wherein the second compartment rotates in relation to the first compartment to longitudinally displace the seal from the passage.

6. The apparatus of claim 4, further comprising a second compartment receiving recess attached to the first compartment, the second compartment receiving recess configured to receiving the second compartment, wherein the longitudinal displacement of second compartment withdraws the second compartment from the second compartment receiving recess.

7. The apparatus of claim 6, further comprising a pin disposed through a wall of the second compartment receiving recess, the pin configured to engage a groove in a wall of the second compartment, the groove having at least one section at an angle greater than ninety degrees with respect to a common axis between first compartment and the second compartment such that rotation of the second compartment with respect to the first compartment in a first direction forces the pin to a position further away from a top of the second compartment such that the second compartment is positioned deeper in the recess.

8. The apparatus of claim 7, wherein a rotation of the second compartment with respect to the first compartment in a second direction forces the pin to a position closer to a top of the second compartment such that the second compartment is positioned shallower in the recess.

9. The apparatus of claim 1, further comprising a plurality of inclusions disposed in an end of the first compartment, and a plurality of inclusions are disposed in an end of the base of the first compartment and the lid of the second compartment.

10. The apparatus of claim 9, wherein the plurality of inclusions of the first compartment is configured to receive and retain a plurality of inclusions of the base of the first compartment in a plurality of predetermined positions such that the first compartment is aligned axially and retained to the second compartment relative to the similar axis.

11. The apparatus of claim 9, wherein the plurality of inclusions disposed in an end of the first compartment and the plurality of inclusions disposed in an end of a base of the first compartment form an effective seal.

12. The apparatus of claim 11, wherein the formed seal between the plurality of inclusions disposed in an end of the first compartment and the plurality of inclusions disposed in an end of a base of the first compartment is formed by mechanical forces.

13. The apparatus of claim 9, wherein the plurality of inclusions disposed in an end of the first compartment and a plurality of inclusions disposed in an end of a base of the first compartment allow of torsional or rotational manipulation of the apparatus while selectively inhibiting undesired vertical motion.

14. The apparatus of claim 1, wherein the first compartment and the second compartment are approximately cylindrical, and coextensive.

15. The apparatus of claim 1, wherein the seal seals the second compartment within a second compartment receiving recess.

16. The apparatus of claim 1, wherein the apparatus comprises a baby bottle.

17. The apparatus of claim 1, further comprising;
a second compartment receiving recess configured to receive the second compartment;
a pin disposed through the second compartment receiving recess, the pin configured to engage a groove in the second compartment; and
a groove disposed on the second compartment, the groove having at least one section at an angle greater than ninety degrees with respect to a common axis between first compartment and the second compartment such that rotation of the second compartment with respect to the first compartment in a first direction forces the pin to a position further away from the first end of the second compartment such that the second compartment is positioned deeper in the second compartment receiving recess, wherein rotation of the second compartment with respect to the first compartment in a second direction forces the pin to a position closer to the first end of the second compartment such that the second compartment is positioned shallower in the second compartment receiving recess.

18. The apparatus of claim 1, wherein the second compartment is slideably received within a second compartment receiving recess such that the displacement of the seal from the first passage results as the second compartment is withdraw from the second compartment receiving recess.

19. A method of selectively mixing two substances, the method comprising:
filling a first compartment with a first substance;
sealing a passage in the first compartment with a selectively operable seal;
joining the first compartment to a the second compartment;
filling the second compartment with a second substance; and
mixing the first substance with the second substance by removing the seal from the passage.

20. An apparatus for feeding a child, the apparatus being capable of selectively mixing a first substance and a second substance, the apparatus comprising:
a first compartment comprising a first end and a second end, the first compartment configured to retain the first substance;
a passage disposed in the second end of the first compartment;
a second compartment comprising a first end and a second end, the second compartment configured to retain a second substance;
a seal attached to the first end of the second compartment;
a second compartment receiving recess attached to the second end of the first compartment, the second compartment received within the second compartment receiving recess such that the seal is disposed against the passage in the second end of the first compartment;
a pin disposed through the second compartment receiving recess, the pin configured to engage a groove in the second compartment; and
a groove disposed on the second compartment, the groove having at least one section at an angle greater than ninety degrees with respect to a common axis between first compartment and the second compartment such that rotation of the second compartment with respect to the first compartment in a first direction forces the pin to a position further away from the first end of the second compartment such that the second compartment is positioned deeper in the second compartment receiving recess, wherein rotation of the second compartment with respect to the first compartment in a second direction forces the pin to a position closer to the first end of the second compartment such that the second compartment is positioned shallower in the second compartment receiving recess.
